(19) United States
(12) Patent Application Publication
(10) Pub. No.: US 2026/0140329 A1
(43) Pub. Date: May 21, 2026

(54) DEVICES AND METHODS FOR COUPLING COMPOSITE CONDUCTORS

(71) Applicant: TS Conductor Corp., Huntington Beach, CA (US)

(72) Inventors: Jianzhong Jason HUANG, San Clemente, CA (US); Usama AHMED, Coquitlam (CA)

(21) Appl. No.: 19/388,625

(22) Filed: Nov. 13, 2025

Related U.S. Application Data
(60) Provisional application No. 63/720,869, filed on Nov. 15, 2024.
(60) Provisional application No. 63/897,388, filed on Oct. 10, 2025.

(51) Int. Cl. G02B 6/38

(52) U.S. Cl. CPC G02B 6/3857; G02B 6/3838

(57) ABSTRACT

A coupler includes a body defining a channel therethrough, and a material disposed around the body. The coupler is movable between a first configuration in which an end of a conductor is removably disposed in the channel defined by the coupler, the conductor including a strength member including: a core formed from a composite material and an encapsulation layer disposed around the core, and a conductor layer disposed around the strength member, and a second configuration in which the coupler is crimped to cause the coupler to be fixedly coupled to the end of the conductor. The coupler may include a body including multiple segments. A sleeve may be disposed around the body. Methods of coupling couplers to conductors using backward press crimping are also described.

### CROSS-REFERENCE TO RELATED APPLICATIONS

The application claims priority to and the benefit of U.S. Provisional Patent Application No. 63/720,869, filed Nov. 15, 2024, and titled, “Devices and Methods for Coupling Composite Conductors,” and U.S. Provisional Patent Application No. 63/897,388, filed Oct. 10, 2025, and titled, “Devices and Methods for Coupling Composite Conductors,” the disclosures of which are hereby incorporated herein by reference in their entirety.

### TECHNICAL FIELD

The embodiments described herein relate generally to methods and apparatus for coupling composite conductors that are used in grid transmission and distribution applications.

### BACKGROUND

The electrical grid is a major contributor to greenhouse emissions and global warming. It is estimated that about 1 billion metric tons of greenhouse gas emissions are released annually and associated with the transport of electricity via the electrical grid. Moreover, most of the existing transmission lines (i.e., conductors or conductor lines) making up the electrical grid are inefficient and antiquated. For example, much of the US electrical grid was built in the 1960s and 1970s, and the US Department of Energy estimates that about 70 percent of existing transmission lines are nearing the end of their 50-year lifecycle. In addition, conventional transmission line conductors, typically using coaxial cables of steel and/or aluminum wires to conduct and transmit electricity through the grid, are plagued by inefficiencies due to high resistive, capacitive, and inductive line losses. It is estimated that about 2,000 TWh of electricity is wasted annually due to such losses. As the demand for electricity grows, there is an increased demand for higher capacity electricity transmission and distribution lines. Numerous distribution lines are coupled to each other and to towers via couplers (e.g., splicing or dead end couplers) to span over long distances. Coupling the distribution or transmission conductors to couplers can take significant amount of time and manpower which can increase installation costs. Moreover, coupling composite conductors using conventional couplers and coupling methods can cause flow of materials included in such composite conductors towards the inside/interior, i.e., the bulk material, of the couplers, and pressure build-up. This can damage the coupler and injure line crew and is unacceptable and/or undesirable. In addition, conventional coupling can cause compressive stress at high temperature operation and cause spallation or building up of fracture stresses on the conductor. Conventional coupling can also cause improper contact resistance due to poor handling of excess extruded material resulting due to crimping forces exerted on the conductor and the coupler. This resistance leads to a temperature rise increasing the resistance more and causing thermal runaway. Another common issue in conventional coupling methods is damage to the optical fiber due to the excess material back flowing into the gap at the end of the core.

### SUMMARY

Embodiments described herein relate generally to methods and apparatuses for coupling electrical conductors to couplers or dead ends using crimping. In particular, embodiments described herein relate to methods, apparatuses and couplers or connectors for coupling conductors that include a strength member including a composite core and an encapsulation layer disposed around the composite core, and, optionally, a conductor layer, or a plurality of conductor layers, disposed on the strength member, to dead-end couplers, splicing couplers, or any other couplers using crimping, such as backward press crimping, and/or using multipiece couplers that can accommodate flow of conductor material therewithin. In some embodiments, coupling of the conductors to couplers, for example, via backward press crimping is performed via a swage apparatus.

In some embodiments, a method includes removing a portion of a first conductor layer from an end of a first conductor to expose a portion of a first strength member. The method also includes inserting the end of the first strength member into a channel defined by a coupler; removing a portion of a second conductor layer from an end of a second conductor to expose a portion of a second strength member. The end of the second strength member is inserted into the channel defined by the couple. The method also includes causing, via a crimping apparatus, backward press crimping of the coupler to the first strength member and the second strength member.

In some embodiments, a method includes removing a portion of a first conductor layer from an end of a first conductor to expose a portion of a first strength member. The method also includes inserting the end of the first strength member into a channel defined by a coupler. The method also includes removing a portion of a second conductor layer from an end of a second conductor to expose a portion of a second strength member. The end of the second strength member is inserted into the channel defined by the coupler. A swage apparatus is disposed around the coupler in a first position in which a gap exists between an inner surface of the swage apparatus and the coupler and transitioning the swage apparatus from the first position to a second position in which the inner surface of the swage apparatus contacts the coupler and causes backward press crimping of the coupler to the first strength member and the second strength member.

In some embodiments, a method includes removing a portion of a conductor layer from an end of a conductor to expose a portion of a strength member. The method also includes inserting the end of the first strength member into a channel defined by a coupler and disposing a swage apparatus around the coupler in a first position in which a gap exists between an inner surface of the swage apparatus and the coupler. The method also includes transitioning the swage apparatus from the first position to a second position in which the inner surface of the swage apparatus contacts the coupler and causes backward press crimping of the coupler to the strength member.

In some embodiments, a coupler includes: a first portion including: a first axial end configured to be coupled to a strength member of a conductor, the strength member including a core including a composite material and an encapsulation layer disposed around the core, a conductor layer disposed around the strength member, the strength member extending beyond an axial edge of the conductor layer to be coupled to the first potion; and a second axial end having a cross-sectional area greater than a cross-sectional area of the first axial end of the first portion; a second portion configured to be coupled to the second axial end of the first portion; and a third portion disposed around at least a portion of the first portion, the second portion, and the conductor, the third portion configured to be coupled to the conductor and the second portion.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of an assembly including a conductor and a coupler configured to be coupled to the conductor, according to an embodiment.

FIG. 2A is a schematic illustration of a conductor having an axial end thereof disposed in a coupler in an uncoupled configuration having one or more gaps between a portion of the conductor and an inner wall of the coupler, the coupler having one or more grooves, according to an embodiment. FIG. 2B is a schematic illustration of the conductor and the coupler of FIG. 2A in a coupled configuration in which the conductor is coupled to the coupler after crimping, the one or more grooves capturing at least a portion of an excess material.

FIG. 2C is a schematic illustration of a conductor of having an axial end thereof disposed in a coupler in an uncoupled configuration having one or more gaps between a portion of the conductor and an inner wall of the coupler, the coupler having one or more grooves, the coupler including two segments separated by a spacer, according to an embodiment. FIG. 2D is a schematic illustration of the conductor and the coupler of FIG. 2C in a coupled configuration having removed or decreased gap size of at least one of the one or more gaps, the one or more grooves capturing at least a portion of an excess material, according to an embodiment.

FIG. 3A is a schematic illustration of a first conductor and a second conductor having axial ends thereof disposed in a in an uncoupled configuration having one or more gaps between a portion of the first conductor and/or a portion of the second conductor and/or between a portion of the first conductor or the second conductor and a portion of an inner wall of the coupler, the coupler having one or more grooves, according to an embodiment; FIG. 3B is a schematic illustration of the coupler and first and second conductors of FIG. 3A in coupled configuration in which the first and second conductors coupled to each other via the coupler after crimping, according to an embodiment. the one or more grooves capturing at least a portion of an excess material.

FIG. 3C is a schematic illustration of a first and a second conductor, each having an axial end thereof disposed in a coupler having a plurality of body segment and one of the one or more gaps and one or more grooves, in an uncoupled configuration, according to an embodiment. FIG. 3D is a schematic illustration of the first and second conductors and the coupler of FIG. 3C in a coupled configuration having removed at least one of the one or more gaps or decreased a gap size of at least one of the one or more gaps, the one or more grooves capturing at least a portion of an excess material, according to an embodiment.

FIG. 4 is a schematic flow chart of a method for coupling a conductor to a coupler using a crimping apparatus, according to an embodiment.

FIG. 5 is a schematic flow chart of a method for coupling a first conductor to a second conductor via a coupler using a crimping apparatus, according to an embodiment.

FIG. 6 is a perspective view of a swage apparatus, according to an embodiment.

FIG. 7A is a schematic illustration of a conductor having an axial end thereof disposed in a coupler in an uncoupled configuration with a swage apparatus disposed therearound, according to an embodiment. FIG. 7B is a schematic illustration of the conductor and the coupler of FIG. 7A in a coupled configuration in which the conductor is coupled to the coupler via the swage apparatus.

FIG. 7C is a schematic illustration of a portion of FIG. 7A-7B in which the swage apparatus has an inclined surface to facilitate backward press crimping, according to an embodiment.

FIG. 8A is a schematic illustration of a first conductor and a second conductor having axial ends thereof disposed in a coupler in an uncoupled configuration with a swage apparatus disposed therearound, according to an embodiment, FIG. 8B is a schematic illustration of the coupler and first and second conductors of FIG. 8A in coupled configuration in which the first and second conductors are coupled to each other via the swage apparatus.

FIG. 8C is a schematic illustration of a portion of FIG. 8A-8B in which the swage apparatus has an inclined surface facing the conductor to facilitate backward press crimping, according to an embodiment.

FIG. 9 is a schematic illustration of an assembly including a conductor coupled to a coupler, according to an embodiment.

FIG. 10 is a schematic illustration of a conductor having an axial end thereof coupled to a coupler, according to an embodiment.

FIG. 11 is a schematic illustration of a conductor coupled to a coupler, according to an embodiment.

FIG. 12A is a schematic illustration of a first conductor and a second conductor having axial ends thereof coupled to each other via a coupler, according to an embodiment.

FIG. 12B is a schematic is a schematic illustration of a first conductor and a second conductor having axial ends thereof coupled to each other via a coupler, according to an embodiment.

FIG. 13 is a schematic flow chart of method for coupling a conductor to a coupler, according to an embodiment.

FIG. 14 is a schematic flow chart of a method for coupling a first conductor to a second conductor via a coupler, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to methods and apparatuses for coupling electrical conductors to couplers using crimping. In particular, embodiments described herein relate to methods and apparatuses for coupling conductors that include a strength member including a composite core and an encapsulation layer disposed around the composite core, and a conductor layer disposed on the strength member, to dead-end couplers, splicing couplers, or any other couplers using backward press crimping, and/or using multipiece couplers that can accommodate flow of conductor material therewithin In some embodiments, coupling of the conductors to couplers, for example, via backward press crimping is performed via a swage apparatus.

The electrical grid of the United States is quickly becoming outdated, and major portions of the grid will require replacement in the near future. For example, the American Society of Civil Engineers reported that an estimated 70% of transmission and distribution lines are well into the second half of their 50-year life expectancy, and some lower voltage components are even over 100 years old. Meanwhile, PJM, a regional electrical transmission organization, reported that nearly two-thirds of all bulk electric system assets on their grid are more than 40 years old while more than one third of their transmission assets are more than 50 years old. Likewise, the Western Area Power Administration and the Southwestern Power Administration built the foundation of the electrical grid in the Central U.S. in the 1940s and 1950s.

As described herein, these aging conventional transmission line conductors, typically using coaxial cables of steel and/or aluminum wires to conduct and transmit electricity through the grid, are plagued by inefficiencies due to high resistive, capacitive, and inductive line losses. For example, conventional conductors with steel cores are heavy and have high thermal expansion and thermal sag, which compounds these losses. Alternatively, more modern conductors with Invar cores are expensive and have limited use cases due to their poor tensile strength and high impedance. Similarly, existing composite reinforced conductors, such as aluminum conductors with ceramic reinforcement or carbon fiber composite core conductors, are expensive or difficult to manufacture and vulnerable to bending failures due to poor tensile or compressive strength. Such conventional conductor technologies, which are currently employed in the U.S. for commercial energy distribution, are estimated to waste about 2,000 TWh of electricity due to the resistive, capacitive, and inductive losses during transmission.

Meanwhile, regulators and legislators across the country are establishing mandates to accelerate a transition to renewable energy generation in response to climate change. The U.S. government has also set a goal of zero-carbon electricity by 2035, and a zero-carbon economy by 2050. Accordingly, decarbonization and clean energy procurement targets set by states, utilities, and corporations in the not-so-distant future will require an increase in energy capacity to be quickly and efficiently integrated into the power grid. The influx of energy capacity will necessitate a corresponding increase in transmission capacity to alleviate or prevent congestion and fix reliability issues that may arise as a result. While new, large-scale transmission infrastructure will be a key component to assist in this clean energy transition, regulatory and planning obstacles often get in the way of implementation, and conventional conductor technologies will likely not provide the current-carrying capacity (i.e., ampacity) needed to meet the increased energy demands due to their inherent losses. Therefore, improving the current grid infrastructure may be a more efficient solution for providing more electrical transmission while reducing transmission losses. This may be accomplished, for example, by replacing conventional conductors nearing the end of their service life with lighter, stronger, and higher ampacity conductors that can be easily integrated into the grid while enabling traceability of each individual conductor and analysis of operating parameters or performance over its entire service life (e.g., operating temperature, sag, tension load, etc.).

Another challenge to modernizing the electrical grid is the installation, mounting, or laying down of new electrical conductors, particularly coupling conductors to each other via splicing couplers or to dead end couplers for terminating the conductor at an electrical pole or tower. Crimping couplers to couplers can typically be accomplished in two ways-forward press crimping or backward press crimping. Crimping is conventionally performed using a forward press motion (i.e., “forward press crimping”). When using a forward press motion for coupling a conductor to a dead end coupler, the crimping generally starts proximate an axial end of the conductor towards a bulk of the conductor, i.e., from the end that is being coupled to (e.g., inserted into the dead end coupler, and forwards towards the bulk of the conductor. This is also the case with splicing couplers, where the crimping starts from a point proximate to a midpoint of the splicing coupler where an axial end of the conductor is located, and then crimping is continued outwards or forward towards the conductor.

In contrast, backward press crimping may be performed in a backward press motion in which crimping starts proximate an end of a dead end coupler and proceeds towards the inside of the dead end coupler, or in the case of splicing, crimping starts proximate at least one end of the couplers being spliced and goes towards a middle point of the splicing coupler for each of the two conductors being spliced. In either case, a portion of material may be removed from the conductor or the coupler, and disposed (e.g., squeezed) into a cavity inside the dead end or splicing coupler to generate an excess material. The excess material generally migrates from a start of the crimping motion towards an end of the crimping motion.

Forward press crimping is generally seen as a safer alternative to the backward press crimping in the field because the excess material generated during crimping may flow back towards the bulk of the conductor and remain in the conductor and/or the coupler thereby protecting an operator from being struck by excess material. Meanwhile, with the backward press crimping, if carried out improperly or with inadequate couplers or equipment, the excess material may build up within the coupler which may generate a corresponding increase in pressure within the coupler. This can lead to damage of the coupler, damage of the conductor, and/or safety risks for the operator, for example, explosion of the coupler due to excess pressure being built therein, thereby causing shards of the coupler hitting the operator, which is a significant safety concern. One cause of this safety concern is that conventional dead end or splicing couplers have an inadequate amount of extra space therewithin to accommodate flow of the excess conductor material during crimping. For example, conventional dead end couplers are structured such that the axial end of the conductor is inserted all the way in a cavity defined by the conventional dead end couplers, until the axial end contacts a back wall of the dead end coupler. Similarly, conventional splicing couplers are designed such that the axial ends of opposing conductors are inserted until they touch each other. In either case, there is no space to accommodate the flow of material as a result of crimping, which can lead to cracking or breaking of such conventional couplers, and in the worst case scenario, explosion of such conventional couplers during crimping. Therefore, forward press crimping is generally used to couple conventional couplers to conventional conductors.

Different from conventional conductors, the conductors described herein include composite conductors that include a strength member that has a composite core surrounded by an encapsulation layer (e.g., an aluminum encapsulation layer), and a conductor layer (e.g., aluminum strands) that carries the electrical energy to be communicated therethrough, is disposed on the strength member. Coupling the composite conductors described herein to couplers generally includes coupling an exposed portion of the composite conductor to an inner portion of the coupler (e.g., an inner steel tube), and an outer portion of the coupler (e.g., an outer aluminum sleeve) to the conductor layer, for example, via crimping.

In such composite conductors, using forward press crimping can push a portion of the encapsulation layer and/or the conductor layer towards the conductor, which can cause damage to at least a portion of the conductor located proximate to the axial end, for example, due to delamination of the encapsulation layer that can further cause delamination of a portion of the conductor layer, compaction, and/or generation of thermal hot spots during operation (e.g., due to temperature cycling). For example, the condition of the aluminum strands may revert from tension to compression. It can also lead to separation and potential spallation between layers in the conductor.

This is more challenging for short span (e.g., 8 ft to 12 ft length) conductors, such as those used during testing such conductors. In such instances, even slight damage to the axial end of the conductor due to forward press crimping can significantly impact the performance during testing, and is undesirable. Such complications may also lead to different testing outcomes or failures in a laboratory testing, which may differ than actual performance in the field where the span distance between towers can be as much as 800 ft to 1,200 ft long, and the actual distance between fittings can be as much as 5,000 ft or longer. While such excess material may be tolerable for long length conductors (e.g., greater than 100 feet span), utilities desire the same process that is used for coupling conductors during testing, to be used in the field. Therefore, should safety issues be resolved, it would be advantageous to couple conductors via the backward press crimping method in both short span laboratory settings and longer span settings in the field for the composite conductors described herein, but also for conventional conductors. Backward press crimping may be performed, for example, to couple a coupler to the strength member inside the coupler (e.g., body of coupler, such as steel tubes) and/or to couple a sleeve of the coupler (e.g., aluminum sleeve) to the conductor layer disposed in the sleeve (e.g., aluminum sleeves).

In addition, coupling of the conductors described herein via forward press crimping, or even with backward press crimping using improper equipment, can result in thermal runaway. For example, when crimping or swaging is done improperly or the coupler being coupled with conductor is not designed properly, there can be issues with handling of excess extruded material. If not done properly, the extruded material can cause improper contact resistance that can lead to temperature rise and thereby, resistance increase that can further lead to thermal runaway. In some instances, using forward press coupling on the conductors described herein can cause the encapsulation layer of the strength members of the conductors described herein can undergo a compressive stress that, under high temperature operation thermal expansion, can cause spallation or build up fracture (e.g., compressive stress) in the encapsulation layer. Additionally, the conductors described herein may include optical fibers disposed therein that can be damaged if the extruded material of the encapsulation layer flows towards the optical fibers during coupling.

Accordingly, embodiments of the methods and apparatus described herein for coupling conductors that include a strength member and a conductor layer disposed around the strength member, to couplers via crimping (e.g., backward press crimping) using a crimping apparatus (e.g., swage apparatus) may provide one or more benefits including, for example: 1) providing a strength member that has a gap free encapsulation layer around a composite core that inhibits presence of air, oxygen, and/or electrolytes at the interface between the encapsulation layer and the core, thereby protecting encapsulation layer and core interface from corrosion, and the core from oxidation, moisture plasticization, ultraviolet (“UV”) light, corrosion, and environmental degradation; 2) protecting the composite core from compression and bending failures via the encapsulation layer; 3) providing cushioning via the encapsulation layer to protect the composite core during coupling of the conductor with couplers by implosion force exerted during the coupling (e.g., crimping process), thereby reducing installation cost; 4) increasing conductor strength and preserve residual tension in the composite core during manufacturing of the strength member such that any compressive stress in the conductor has to first overcome the pre-existing tension in the composite core, thereby delaying buildup of compressive stress and inhibiting compression buckling failure that is associated with conventional conductors, as well as increasing bending stiffness; (6) enabling safe and reliable backward press crimping of conductors in the field and in lab test environments; (7) providing gaps or cavities configured to receive excess material generated during crimping such that the conductors remain substantially free from damage and technicians remain safe; (8) reducing damage to conductors or couplers during coupling by enabling backward press crimping such that excess material moves away from the conductor and into a gap or a cavity; (9) providing better quality couplings, reducing installation complexity, reducing overall cost, and reducing project completion times; (10) reducing voids between couplers and conductors, thus reducing coupling resistance as well as inhibiting corrosion by inhibiting moisture ingress in the coupling; (11) inhibiting corona formation, thereby inhibiting formation of hotspots and reducing failure; (12) reducing thermal runaway during coupling; (13) inhibiting flow of encapsulation layer during coupling towards the core to protect the core and/or optical fibers disposed therein; and (14) increasing compressive strength of the couplers.

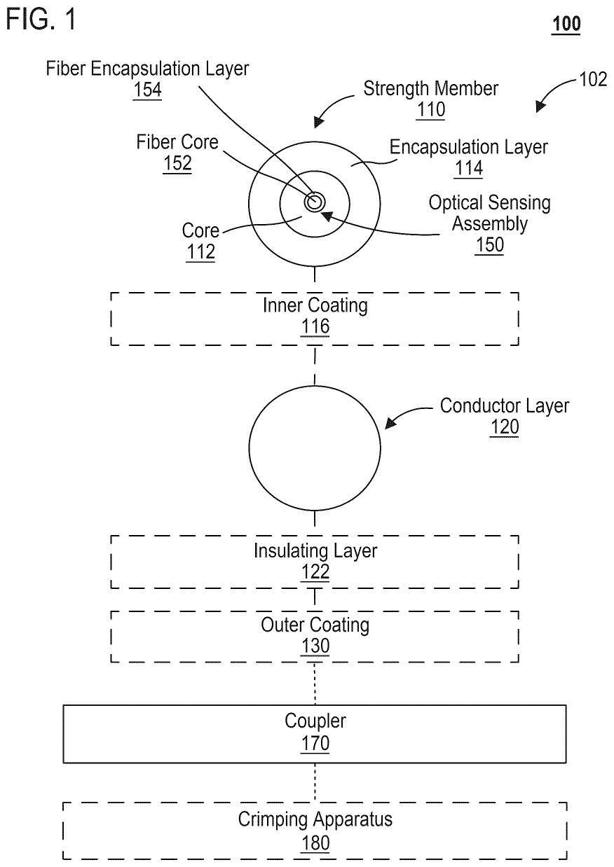

FIG. 1 is a schematic illustration of an assembly 100 including at least one conductor 102 coupleable to a coupler 170, according to an embodiment. The coupler 170 may include a splice coupler configured to couple two conductors to each other (e.g., couple a first conductor 102 to a second conductor 102), a dead end coupler, configured to couple the conductor 102 to a pole or tower, or any other suitable coupler as described herein.

The conductor 102 includes a strength member 110 including a composite core 112 (also referred to herein as “core 112”) and an encapsulation layer 114 disposed around the core 112. An optical fiber assembly 150 disposed in the core. A conductor layer 120 is disposed around the strength member 110, and optionally, an insulating layer 122 is disposed on the conductor layer 120. In some embodiments, an outer coating may be 130 disposed on the insulating layer 122 or the conductor layer 120, and/or an inner coating may be 116 disposed around strength member 110 i.e., between the conductor layer 120 and the strength member 110. In some embodiments, the encapsulation layer 114 is disposed circumferentially around the core 112.

The core 112 may be formed from a composite material. In some embodiments, the composite material may include nonmetallic fiber reinforced metal matrix composite, carbon fiber reinforced composite of either thermoplastic or thermoset matrix, or composites reinforced with other types of fibers such as quartz, AR-Glass, E-Glass, S-Glass, H-Glass, silicon carbide, silicon nitride, alumina, basalt fibers, especially formulated silica fibers, any other suitable composite material, or any combination thereof. In some embodiments, the composite material includes a carbon fiber reinforced composite of a thermoplastic or thermoset resin. The reinforcement in the composite strength member(s) can be discontinuous, for example, include whiskers or chopped fibers, or continuous fibers in substantially aligned configurations (e.g., parallel to axial direction) or randomly dispersed (including helically wind or woven configurations). In some embodiments, the composite material may include continuous or discontinuous polymeric matrix composites reinforced by carbon fibers, glass fibers, quartz, or other reinforcement materials, and may further include fillers or additives (e.g., nanoadditives). In some embodiments, the core 112 may include a carbon composite including a polymeric matrix of epoxy resin cured with anhydride hardeners.

The core 112 may have any suitable cross-sectional width (e.g., diameter). In some embodiments, the core 112 has a diameter in a range of about 3 mm to about 15 mm, inclusive (e.g., 3, 4, 5, 6, 7, 8, 9, 10, 11, 12, 13, 14, or 15 mm, inclusive). In some embodiments, the core 112 may have a diameter in a range of about 5 mm to about 10 mm, inclusive. In some embodiments, the core 112 may have a diameter in a range of about 10 mm to about 15 mm, inclusive. In some embodiments, the core 112 may have a diameter in a range of about 7 mm to about 12 mm, inclusive. In some embodiments, the core 112 may have a diameter of about 9 mm.

The core 112 may have a first glass transition temperature (e.g., for thermoset composites), or melting temperature (e.g., for thermoplastic composites). In some embodiments, the first glass transition temperature or melting temperature is in a range of about 100 degrees Celsius to about 350 degrees Celsius, inclusive (e.g., about 100, about 110, about 120, about 130, about 140, about 150, about 160, about 170, about 180, about 190, about 200, about, 210, about 220, about 230, about 240, about 250, about 260, about 270, about 280, about 290, about 300, about 310, about 320, about 330, about 340, or about 350 degrees Celsius, inclusive). In some embodiments, the first glass transition temperature or melting temperature may be at least about 70 degrees Celsius (e.g., at least 100, at least 120, at least 140, at least 150, at least 160, at least 180, at least 200, at least 220, at least 240, at least 250, at least 260, at least 270, at least 280, at least 290, or at least 300, degrees Celsius, inclusive).

The glass transition temperature or melting temperature of the core 112 may correspond to a threshold operating temperature of the conductor 102, which may limit the ampacity of the conductor 102. In other words, a maximum amount of current that can be delivered through the conductor 102 is the current at which the operating temperature of the conductor 102, or at least the temperature of the core 112 is less than the glass transition temperature or melting temperature of the composite core 112.

In some embodiments, the core 112 defines a circular cross-section. In some embodiments, the core 112 may define an ovoid, elliptical, polygonal, or asymmetrical cross-section. In some embodiments, the strength member 110 may include a single core 112. In other embodiments, the strength member 110 may include multiple cores, for example, 2, 3, 4, or even more, with the encapsulation layer 114 being disposed around the multiple cores or around each individual core. In such embodiments, each of the multiple cores may be substantially similar to each other, or at least one of the multiple cores may be different from the other cores (e.g., have a different size, different shape, formed from a different material, have components such as the optical fiber assembly 150 embedded therein, etc.).

In some embodiments, an optical fiber assembly 150 (e.g., one or more optical fiber assemblies) may be disposed in the core 112, for example, embedded within the core 112 during the manufacturing of the core 112, or otherwise during manufacturing of the strength member 110. The optical fiber assembly 150 may be disposed axially along or otherwise parallel to a central axis of the core 112 and may extend along an entire length of the core 112, and thereby, the conductor 102. The optical fiber assembly 150 includes a fiber core 152 and a fiber encapsulation layer 154 disposed around the fiber core 152. The fiber core 152 may include an optical fiber (e.g., a single-mode optical fiber, a multi-mode optical fiber, a graded index fiber, a step index fiber, a glass optical fiber, a plastic optical fiber, any other suitable optical fiber or combination thereof) that is capable of transmitting optical energy or light having a wavelength in a range of about 100 nm to about 1 mm, inclusive (e.g., from the ultraviolet to the infrared range). In some embodiments, the fiber core 152 may also include a cladding (not shown) disposed around a central core (e.g., a glass cladding) and configured to inhibit transmission of optical energy therethrough to prevent transmission losses. Moreover, the fiber encapsulation layer 154 may include one or more layers, for example, a protective layer, a thermal resistant layer, an external jacket, and/or a moisture exclusion layer. Various examples of the optical fiber assembly 150 that may be disposed in the core 112 are described in PCT Publication No. WO2024/091951 (the “'951 publication”), published May 2, 2024, and entitled “Smart Composite Conductors and Methods of Making the Same,” the entire disclosure of which is incorporated herein by reference.

While FIG. 1 shows the core 112 including a single optical fiber assembly 150, in some embodiments, a plurality of optical fiber assemblies 150 may be disposed in the core 112. In some embodiments, the one or more optical fiber assemblies 150 may be loosely packed inside the composite core 112 such that it is strongly bonded to the composite material of the core 112, but the loose packing beneficially reduces micro-bending of optical fibers.

The encapsulation layer 114 is disposed around the core 112, for example, circumferentially around the core 112. In some embodiments, an inner insulation layer (not shown) may optionally be interposed between the core 112 and the encapsulation layer 114. The inner insulation layer may be formed from any suitable insulative material, for example, glass fibers (disposed either substantially parallel to axial direction or woven or braided glass), a resin layer, an insulative coating, any other suitable insulative material or a combination thereof. In some embodiments, the inner insulation layer may also be disposed on axial ends of the core 112, for example, to protect the axial ends of the core 112 from corrosive chemicals, environmental damage, etc.

The encapsulation layer 114 may be formed from any suitable electrically conductive or non-conductive material. In some embodiments, the encapsulation layer 114 may be formed from a conductive material including, but not limited to aluminum (e.g., 1350-H19), annealed aluminum (e.g., 1350-0), aluminum alloys (e.g., Al—Zr alloys, 6000 series Al alloys such 2201-TSI, -T82, -T83, 7000 series Al alloys, 8000 series Al alloys, etc.), copper, copper alloys (e.g., copper magnesium alloys, copper tin alloys, copper micro-alloys, etc.) , any other suitable conductive material, or any combination thereof. In some embodiments, the encapsulation layer 114 is formed from Al and is pretensioned, i.e., is under tensile stress after being disposed on the core 112. In some embodiments, the encapsulation layer 114 may be formed from a non-conductive material, e.g., polymers, carbon fiber, glass fiber, ceramics, silicone, rubber, polyurethane, any other suitable non-conductive material, or a combination thereof.

The encapsulation layer 114 may be disposed on the core 112 using any suitable process. In some embodiments, the encapsulation process for disposing the encapsulation layer 114 around the core 112 may employ a conforming machine. For example, the encapsulation process may be performed with a similarly functional machine other than a conforming machine, and be optionally further drawn to achieve target characteristics of the encapsulation layer 114 (e.g., a desired geometry or stress state). The conforming machines or the similar machines used for disposing the encapsulation layer 114 may allow quenching of the encapsulation layer 114. The conforming machine may be integrated with stranding machine, or with pultrusion machines used in making fiber reinforced composite strength members. While FIG. 1B shows a single encapsulation layer 114 disposed around the core 112, in some embodiments, multiple encapsulation layers 114 may be disposed around the core 112. In such embodiments, each of the multiple encapsulation layers 114 may be substantially similar to each other, or may be different from each other (e.g., formed from different materials, have different thicknesses, have different tensile strengths, etc.). In some embodiments, core 112 may include a carbon fiber reinforced composite, and the encapsulation layer 114 may include aluminum, for example, pretensioned or precompressed aluminum.

In some embodiments, the interface between the core 112 and the encapsulation layer 114 may include surface features, for example, grooves, slots, notches, indents, detents, etc. to enhance adhesion, bonding and/or interfacial locking between a radially outer surface of the core 112 and a radially inner surface of the encapsulation layer 114. Such surface features may facilitate retention and preservation of the stress from pretensioning in the encapsulation layer 114. In some embodiments, the composite core 112 may have a glass fiber or other fiber tow disposed around its outer surface to create a screw shape or twisted surface. In some embodiments, a braided or woven fiber layer is applied in the outer layer of the core 112 to promote interlocking or bonding between the core 112 and the encapsulation layer 114.

In some embodiments, the encapsulation layer 114 may have a thickness in a range of about 0.3 mm to about 5 mm, inclusive, or even higher (e.g., 0.3, 0.5, 1, 1.5, 2.0, 2.5, 3.0, 3.5, 4.0, 4.5, 5.0 mm, inclusive, or even higher). In some embodiments, a ratio of an outer diameter of the encapsulation layer 114 to an outer diameter of the core 112 is in range of about 1.2:1 to about 5:1, inclusive (e.g., 1.2:1, 1.5:1, 2:1, 2.5:1, 3:1, 3.5:1, 4:1, 4.5:1, or 5:1, inclusive). In some embodiments, the encapsulation layer 114 may be excluded.

In some embodiment, the strength member 110 may have a minimum level of tensile strength, for example, at least 600 MPa (e.g., at least 600, at least 700, at least 800, at least 1,000, at least 1,200, at least 1,400, at least 1,600, at least 1,800, or at least 2,000 MPa). In some embodiments, the elongation during pretension of the strength member 110 may include elongation by at least 0.01% strain (e.g., at least 0.01%, at least 0.05%, at least 0.1%, at least 0.15%, at least 0.2%, at least 0.25%, at least 0.3%, at least 0.35%, at least 0.4%, at least 0.45%, or at least 0.5% strain, inclusive) depending on the type of strength members and the degree of knee point reduction, and the strength member 110 may be pre-tensioned before or after entering the conforming machine. Moreover, the strength member 110 may be configured to endure radial compression from crimping of conventional fittings as well as radial pressure during conforming of drawing down process or folding and molding of at least 3 kN (e.g., at least 3, at least 4, at least 5, at least 10, at least 15, at least 20, or at least 25 kN, inclusive), for example for composite cores 112 with little to substantially no plastic deformation.

In some embodiments, the encapsulation layer 114 may have an outer surface that is configured to be smooth and shiny (e.g., surface treated) so as to reduce absorptivity (i.e., enhance solar reflectivity) so as to reduce an operating temperature of the core 112 and to prevent the temperature of the core 112 from exceeding its glass transition temperature or melting temperature. In some embodiments, the outer surface of the encapsulation layer 114 is optionally, at least one of treated or coated with a coating (e.g., the inner coating 116) so as to have a reflectivity of greater than about 50% (e.g., greater than 50%, greater than 60%, greater than 65%, greater than 70%, greater than 75%, greater than 80%, greater than 85%, greater than 90%, or greater than 95%, inclusive) at thermal radiative wavelengths corresponding to an operating temperature of greater than about 90 degrees Celsius. In some embodiments, the outer surface of the encapsulation layer 114 may be surface treated (e.g., plasma treated, texturized, etc.) to have the solar absorptivity as described above.

In some embodiments, the strength member 110, i.e., the outer surface of the encapsulation layer 114 may be optionally coated with an inner coating 116 to reduce solar absorptivity. In some embodiments, the inner coating 116 may include any inner coating having any suitable structure and function as described in detail in U.S. Pat. No. 11,854,721 (the “'721 patent”), issued Dec. 26, 2023, and entitled “Composite Conductors Including Radiative and/or Hard Coatings and Methods of Manufacture Thereof,” the entire disclosure of which is incorporated herein by reference.

The conductor layer 120 is disposed around the strength member 110 and configured to transmit electrical signals therethrough at an operating temperature, for example, in a range of 60 degrees to 250 degrees Celsius, inclusive. In some embodiments, the conductor layer 120 may include a plurality of strands of a conductive material disposed around the strength member 110. For example, the conductor layer 120 may include a first set of conductive strands disposed around the strength member 110 in a first wound direction (e.g., wound helically around the strength member 110 in a first rotational direction), a second set of conductive strands disposed around the first set of strands in a second wound direction (e.g., wound helically around the first set of conducive strands in a second rotational direction opposite the first rotational direction), and may also include a third set of strands wound around the second set of strands in the first wound direction, and may further include any number of additional strands as desired.

In some embodiments, the conductor layer 120 (e.g., a plurality of strands of conductive material) may include, for example, aluminum, aluminum alloy, copper or copper alloy including micro alloy as conductive media, etc. In some embodiments, the conductor layer 120 may include conductive strands including Z, C or S wires to keep the outer strands in place. The conductor layer 120 may have any suitable cross-sectional shape, for example, circular, triangular, trapezoidal, etc. In some embodiments, the conductor layer 120 may include a stranded aluminum layer that may be round or trapezoidal. In some embodiments, the conductor layer 120 may include Z shaped aluminum strands. In some embodiments, the conductor layer 120 may include S shaped aluminum strands. In some embodiment, the conductor 102 may include any of the conductors described in U.S. Pat. No. 9,633,766, filed Sep. 23, 2015, and entitled “Energy Efficient Conductors with Reduced Thermal Knee Points and the Method of Manufacture Thereof,” the entire disclosure of which is incorporated herein by reference.

In some embodiments, the strength member 110 may be adequately tensioned while the conductor layer 120 of aluminum or copper or their respective alloys disposed around the strength member 110 may be applied to cause the conductor 102 to form a cohesive conductive hybrid rod that is spoolable onto a conductor reel. In some embodiments, to facilitate conductor spooling onto a reel and conductor spring back at ease, the conductor 102 may be optionally configured to be non-round (e.g., elliptical) such that the shorter axis (in conductor 102) is subjected to bending around a spool (or a sheaves wheel during conductor installation) to facilitate a smaller bend or spool radius, while the strength members 110 may be configured to have a longer axis to facilitate spring back for installation. The overall conductor 102 may be round with non-round strength member 110 or multiple strength members 110 arranged to be non-round, and the spooling bending direction may be along the long axis of the strength member 110 to facilitate spring back while not overly subjecting the conductor layer 120 with additional compressive force from spooling bending.

To further facilitate spooling of the conductor layer 120 on the strength member 110, in some embodiments, the conductor layer 120 may include multiple segments, for example, strands or sets of strands or wires of conductive material (e.g., 2, 3, 4 etc.), and each segment bonded to strength member 110 while retaining compressive stress, and the segments rotates one full rotation or more along the conductor 102 length (equal to one full spool in a reel) to facilitate easy spooling. Thus, the conductor 102 may be configured to have negligible skin effect (i.e., conducting layer thickness is less than the skin depth required at AC circuit frequency), with the strength member 110 may be under sufficient residual tensile stress, and the conductor layer 120 (e.g., each of the strands of the conductive material) are mostly free of tension or under compressive stress. In some embodiments, the strands of the conductive material may be formed from a conforming machine, for example, by extruding hot deformable (e.g., semi solid) conductive material (e.g., aluminum) from a mold. The strands can be molded to be round or trapezoidal. In some embodiments, the extrusion mold or die may have a stranding lay ratio defined therein so that during the stranding operation of the conductive strands, no shaping may be needed (e.g., removing of sharp corners or edges of the conductive strands to avoid corona as is performed in conventional stranding operations). In some embodiments, the conductive media may be extruded out of the mold or die at an angle so as to form conductive strands that wrap around the strength member 110 at an angle, as described herein.

In some embodiments, for AC applications where skin effect is prominent, the conductor layer 120 may include a plurality of layers of conductive strands disposed concentrically around the strength member 110, with each layer being of finite thickness to maximize skin effect for lowest AC resistance at minimal conductor content. In some embodiments, the conductor layer 120 may be optionally stranded to facilitate conductor spooling around a reasonably sized spool and facilitate conductor stringing. In some embodiments, the outer most strands included in the conductor layer 120 may be TW, C, Z, S, or round strands if more aluminum or copper are used, as it will not cause permanent bird caging problem (i.e., the inner strands of the conductor layer 120 may not be deformed such that they prevent the outer strands from proper resettlement after tension is released or reduced). Accordingly, the smooth outer surface and the compact configuration can effectively reduce the wind load and ice accumulation on the conductor 102, resulting in less sag from ice or wind related weather events.

In some embodiments, the conductor 102 may be pre-stressed, for example, by subjecting the conformed conductor 102 to a paired tensioner approach or trimming the predetermined core 112 length before dead-ending, all accomplished without exerting the high tensile stress to the pole arms to pre-tension conventional conductors in the electric poles. For example, the conductor 102 may be subjected to pre-tensioning treatment using sets of bull wheels prior to the first sheave wheel during stringing operation, without exerting additional load to the electric towers. This can, for example, be accomplished by two sets of tensioners, with the first set maintaining normal back tension to the conductor drum/reel, while the second set restoring the normal stringing tension to avoid excessive load to electric poles or towers, for example, old towers in reconductoring projects.

The conductor 102 may be subjected to the pre-tensioning stress between the first and second tensioners, for example, about 2 times of the average conductor every day tensile load to ensure that the pre-tensioning is driving its knee point below the normal operating temperature so that conductor layer 120 is not in tension for optimal self-damping and the conductor 102 substantially does not change its sag with temperature. In some embodiments, the conductor layer 120 (e.g., each strand of conductive material included in the conductor layer 120) may include aluminum having electrical conductivity of at least 50% ICAS, at least 55% ICAS, at least 60% ICAS, or at least 65% ICAS, or may include copper having electrical conductivity of at least 65% ICAS, at least 75% ICAS, or even at least 95% ICAS.

The conductor 102 may combine pre-tensioning with strength member 110 that may include an encapsulation layer 114 formed of a conductive material of sufficient compressive strength and thickness to substantially preserve the pre-tensioning stress in the strength member 110, while rendering the conductor layer 120 disposed around the strength member 110 mostly tension free or in compression after conductor field installation, and preserving the low thermal expansion characteristics of the strength member 110. The conductor 102 may have an inherently lower thermal knee point. Unlike gap conductors requiring complicated installation tools and process, where the conductor, fitting, installation, and repair are very expensive, the conductor 102 may be easy to install and repair, while maintaining low sag, high capacity, and energy efficiency as a result of knee point shift.

In some embodiments, metallurgical bonding may be provided between the strength member 110 and the conductor layer 120. In some embodiments, adhesives (e.g., Chemlok 250 from Lord Corp) may be applied to the surface of the strength member 110 of the conductor 102 to further promote the adhesion between the strength member 110 and the conductor layer 120 disposed thereon. Additionally, surface features on the strength member 110 may be incorporated to promote interlocking between the conductor layer 120 and the strength member 110 (e.g., stranded strength member 110 such as multi-strand composite cores in C⁷ or steel wires in conventional conductors; pultruded composite core with protruding or depleting surface features; and an intentional rough surface on strength members such as ACCC core from CTC Global where a single or multiple strand glass or basalt or similar and other types of insulating material were disposed around the strength member 110, instead of just the longitudinally parallel configuration described herein). In some embodiments, the conductor layer 120 may include aluminum, aluminum alloy, copper and copper alloys, lead, tin, indium tin oxide, silver, gold, nonmetallic materials with conductive particles, any other conductive material, conductive alloy, or conductive composite, or combination thereof.

It should be appreciated that, the conductor layer 120 may be under no substantial tension while the strength member 110 may be pre-stretched/tensioned. After the pre-tension in the strength member 110 is released, the conductor layer 120 may be subjected to compression, which may minimize the shrinking back of the strength member 110. The strength member 110 made with composite materials may have a strength above 80 ksi, and a modulus ranging from about 5 msi to about 40 msi, inclusive, and a CTE of about 1×10⁻⁶/° C. to about 8×10⁻⁶/° C., inclusive.

The level of pre-tensioning in the conductor 102 may be dependent on conductor size, conductor configuration, conductor application environment and the desirable target thermal knee point. If the goal is to have a conductor thermal knee point at or near the stringing temperature (e.g., ambient), the tension desired onto the strength member 110 may only be about the same stringing sag tension (e.g., about 10% to about 20%, inclusive, of rated conductor strength), plus about 5% to about 50%, inclusive, of the stringing sag tension level (e.g., about 10% to about 30%, inclusive) extra to keep all aluminum included in the conductor layer 120 (or copper in the case of copper conductors) free of tension after stringing, which is significantly lower compared to conductor pre-tensioning in the electric towers where a load about 40% of conductor tensile strength are commonly used. If lower thermal knee point is desired, higher pre-tensioning stress may be used. It is also important to note that the composite core 112 of the strength member 110 may include carbon fibers that are strong, light weight, and have low thermal sag. The encapsulated strength member 110 using fiber reinforced composite materials may be particularly advantageous where the elastic strength member 110 facilitates spring back of the encapsulated strength member 110 from the reeled configuration for field installation. In some embodiments, the strength member 110 may be pre-strained by at least 0.05% (e.g., at least 0.05%, at least 0.1%, at least 0.15%, at least 0.2%, at least 0.25, or at least 0.3%, inclusive).

In some embodiments, for example, for AC transmission applications, the conductor layer 120 may include concentric layers (e.g., strands) of conductive media disposed around the strength member 110 during a conforming process. The skin depth may be adjusted based on transmission frequency. In some embodiments, the skin depth may be in a range of about 6 mm to about 12 mm, inclusive at 60 Hz (e.g., 6, 7, 8, 9, 10, 11, or 12 mm, inclusive), or in a range of about 12 mm to about 20 mm, inclusive at 25 Hz (e.g., 12, 13, 14, or 15 mm, inclusive) for pure copper. For pure aluminum, the skin depth may be in a range of about 9 mm to about 14 mm, inclusive at 25 Hz (e.g., 9, 10, 11, 12, 13, or 14 mm, inclusive) and in a range of about 14 mm to about 20 mm at 60 Hz (e.g., 14, 15, 16, 17, 18, 19, or 20 mm, inclusive). A thickness of each strand of conductive media included in the conductor layer 120 may be less than the maximum allowable depth, for example, to achieve low A/C resistance. In some embodiments, each of the conductive strands included in the conductor layer 120 may include copper having a thickness of up to 12 mm (e.g., up to 12, up to 11, up to 10, up to 9, or up to 8 mm, inclusive). In some embodiments, each of the conductive strands included in the conductor layer 120 may include aluminum having a thickness of up to 16 mm (e.g., up to 16, up to 14, up to 13, up to 12, up to 11, or up to 10 mm, inclusive). In some embodiments, a dielectric coating may be interposed between the conductive strands to optimize for the skin effect. In some embodiments, lubricants may be provided between adjacent conductive strands to facilitate some relative motion of the conductive strands included in the conductor layer 120.

In some embodiments, an interface between the strength member 110 and the conductor layer 120 may be further optimized with surface features in the strength member 110 enhancing interfacial locking and/or bonding between the strength member 110 and the conductor layer 120 to retain and preserve the stress from pretensioning. Such features may include, but are not limited to, protruded features on an outer surface of the strength member 110 (e.g., and outer surface of the encapsulation layer 114 of the inner coating 116) as well as rotation of the strength member 110 around the axial direction. Furthermore, the same features can be incorporated into the interface between subsequent conductive strands included in the conductor layer 120. In some embodiments, the strength member 110 may include a glass fiber tow disposed around its surface to create a screw shape or twisted surface. In some embodiments, a braided or woven fiber layer is applied in the outer layer of the strength member 110 to promote interlocking or bonding between strength member 110 and the conductor layer 120. Steel wires may be shaped with similar surface features. In some embodiments, the strength member 110 may be pretensioned by pretensioning the reinforcement fibers in a matrix of conductive media such as aluminum or copper or their respective alloys. Such reinforcement fibers may include ceramic fibers, non-metallic fibers, carbon fibers, glass fibers, and/or others of similar types.

In some embodiments, an insulating layer 122 (e.g., a jacket) may optionally be disposed around the conductor layer 120. The insulating layer 122 may be formed from any suitable electrically insulative material, for example, rubber, plastics, or polymers (e.g., polyethylene, PTFE, high density polyethylene, cross-linked high density polyethylene, etc.). The insulating layer 122 may be configured to electrically isolate or shield the conductor 102. In some embodiments, the insulating layer 122 may be excluded.

In some embodiments, an outer surface of the conductor layer 120 (e.g., outer surface of the outermost conductive strands or an outer surface of each of the conductive strands) or the insulating layer 122 is treated with features and/or include features to cause the outer surface to have a solar absorptivity of less than 0.6 (e.g., less than 0.55, less than 0.5, less than 0.45, less than 0.4, less than 0.35, less than 0.3, less than 0.25, less than 0.2, less than 0.15, or less than 0.1, inclusive). In some embodiments, the outer surface has a solar absorptivity of less than 0.55. In some embodiments, the outer coating 130 may include any of the outer coatings as described in detail in the '721 patent.

As previously described, the coupler 170 may include a splice coupler, a dead end coupler, or any other suitable coupler, and is configured to be coupled to an end of the conductor 102. The coupler 170 may include a body defining a channel therethrough. In some embodiments, the body may include a cylindrical body, for example, having a circular, oval, rectangular (e.g., square), or other cross sectional shape. The body may be formed from a strong and rigid material. In some embodiments, the body may be formed from a metal or metal alloy, for example, aluminum, alloys, copper, stainless steel, any other suitable material, or any suitable combination thereof. In some embodiments, the coupler 170 and/or the body may include one or more grooves. In some embodiments, the one or more grooves may be configured to receive at least a portion of an excess material generated during coupling. In some embodiments, the coupler 170 may include one or more body segments. In some embodiments, the coupler may include a plurality of body segments. In some embodiments, the plurality of body segments may each be separated by a spacer. In some embodiments, the spacer may be formed of a compressive material. In some embodiments, the coupler 142 may also include a sleeve disposed around or configured to be disposed around the body. The sleeve may include a cylindrical structure. The sleeve may have a length that is longer than a length of the body of the coupler such that the sleeve extends beyond at least one axial end of the body. For example, in embodiments in which the coupler 170 is a splice coupler, the sleeve may extend beyond both axial ends of the body. In other embodiments in which the coupler 170 includes a dead end coupler, the sleeve may extend beyond only one axial end of the body through which the conductor 102 is inserted into the coupler 170.

The sleeve may be formed from a conductive material, for example, aluminum, alloys, copper, stainless steel, any other suitable material, or any suitable combination thereof. The sleeve may be configured to be physically and/electrically coupled to the outer surfaces of the conductor layer 120 of the conductor layer 120 of the conductor 102, for example, only one conductor 102 (e.g., for a dead end coupler), or to outer surfaces of first and second conductor layers 120 of a first and a second conductor 102 to electrically couple the conductor layers of the first and second conductors, as described in further detail herein. In some embodiments, a mark or indicator may be provided or formed on an outer surface of the conductor layer 120 the mark aligned with an outer edge of a corresponding end of the sleeve such that the conductor 102 is inserted only up to a predetermined length into the coupler 170.

In some embodiments in which the coupler 170 includes a dead end coupler, the coupler 170 may include a connecting portion defining a keyhole. The connecting portion may be coupled to the sleeve and/or the body at a second end of the coupler 170 opposite a first end of the coupler 170 through which the conductor 102 is disposed or inserted into the coupler 170. The connecting portion may be configured to be coupled to corresponding hooks or connectors located on poles (e.g., tension towers) from which the conductor 102 may be suspended. In some embodiments, an opening, a throughhole, or aperture may be defined on a wall of the connecting portion adjacent to the body, sleeve, or any other portion of the coupler 170. The optical fiber assembly 150 included in the conductor 102 may be routed out of the coupler 170 through the opening for coupling with a controller or receiver. In some embodiments, the connecting portion of the coupler 149 may be configured to be coupled to a pole (e.g., an electrical pole or tower). For example, a hook, rope, coil, or any other coupling mechanism may be interfaced with the keyhole defined in the connecting portion to couple the coupler 170 to the pole.

The coupler 170 is movable between a first configuration in which an end of the conductor 102 is removably disposed in the channel defined by the coupler 170, and a second configuration in which a portion of the coupler 170 is crimped, for example, via backward press crimping, to cause the coupler 170 to be fixedly coupled to the end of the conductor 102. For example, a portion of the conductor layer 120 may be removed from the end of the conductor 102 to expose a portion of the strength member 110, and the exposed portion of the strength member 110 removably disposed in the channel.

In some embodiments, in the first configuration, one or more gaps may be present between the conductor 102 and the coupler 170 (e.g., formed in the body of the coupler 170) when an axial end of the conductor 102 is inserted into the coupler 170. In some embodiments, the one or more gaps may be configured to receive a portion of an excess material generated during crimping. As previously described, in some embodiments, the coupler 170 and/or the body may include one or more grooves. In some embodiments, the one or more grooves may be configured to receive a portion of the excess material generated during crimping. In some embodiments, the one or more gaps includes a first gap distance. In some embodiments, the second configuration may include one or more gaps having a second gap distance less than the first gap distance. In some embodiments, at least one or more gaps that are present in first configuration are substantially removed, when the coupler 170 is coupled to the axial end of the conductor in the second configuration, such that the gap distance decreases. In some embodiments, the body and/or sleeve of the coupler 170 may include openings, cavities, grooves, channels, voids, etc., defined on an inner wall thereof such that a portion of the excess material flows into, and is disposed in at least one of the gaps and/or one of the openings during backward press crimping. In other words, the gaps and/or or one more openings serve as flow channels or buffer volumes to accommodate the flow of the encapsulation layer 114 and/or the conductor layer 120 during backward press crimping. Thus, damage or explosion of the coupler during backward press crimping because of excess material flow is inhibited. In some embodiments, the coupler 170 (e.g., a dead end or splice coupler) may include at least two pieces, a first portion that has an open end that is coupled to the axial end of a corresponding coupler and accommodates material flow at the open end during backward press crimping, and a second portion (e.g., an eye bolt portion for a dead end coupler, or a second piece of a splicer) that is coupled to the first portion after the first portion has already been crimped to the conductor.

In embodiments, in which the coupler 170 includes a splice coupler, a length of the conductor layer from first ends of each of the first conductor 102 and the second conductor 102 may be removed to expose a portion of the respective strength members 110 of the first and second conductors 102 (e.g., removing a portion having a length in a range of about 150 mm to about 350 mm, inclusive, from the axial end of the conductors 102). For example, a circumcizer, a cutter or any other suitable equipment may be used to make slits or cuts in the conductor layer 120 of a pair of the conductors 102 proximate to axial ends of the conductors 102, and the portion of the conductor layers 120 of the conductors 102 removed or stripped off to expose a portion of their respective strength members 110. Examples of tools that may be used to remove the predetermined length of the conductor layers 120 are described in the '951 publication.

In some embodiments, a first axial end of the first conductor 102 may be inserted into the channel defined by the coupler 170 through a first end of the coupler 170. A first axial end of the second conductor 102 may be inserted into the channel of the coupler 170 through a second end of the coupler 170 opposite the first end. In some embodiments, a mark or indicator may be provided or formed on an outer surface of the conductor layer 120 of the second conductor 102 and the mark aligned with an outer edge of the second end of the sleeve such that the second conductor 102 is inserted only up to a predetermined length into the coupler 170, for example, about the same length that the first conductor 102 is inserted into the coupler 170. In some embodiments, an optical connector (not shown), for example, a LC connector, a SC connector, a ST connector, a MTP/MPO connector, FC connector, MT-RJ connector, E2000 connector, MU connector, SMA connector, DIN connector, D4 connector, opti-jack connector, LX.4 connector, fused-fiber optical coupler, a micro-optics optical coupler, a planar waveguide optical coupler, or any other suitable optical connector or coupler, or any suitable combination thereof, may be disposed into the channel defined by the coupler 170, for example, within the channel defined by the body. First ends of the optical fiber assembly 150 of each of the first and second conductors 102 may be exposed and inserted into the optical connector to optically couple the optical fiber assembly 150 of the first conductor 102 to the optical fiber assembly 150 of the second conductor 102.

In some embodiments, inserting the first ends of the first and second conductors 102 include positioning the exposed portions of the strength members 110 of the first and second conductor 102 within a portion of the channel defined by the body of the coupler such that corresponding ends of the conductor layers 120 of each of the first and second conductors 102 are positioned in a portion of the coupler 170 that is outside the body, for example, within the sleeve of the coupler 170. In some embodiments, the body and the sleeve have inner cross-sectional widths (e.g., diameters) that are larger than corresponding outer cross-sectional widths of the strength members 110 and the conductor layers 120 of the first and second conductors 102. This allows a gap to be present between inner surfaces of the body and the sleeve and corresponding outer surfaces of the strength member 110 and the conductor layer 120 when axial ends the first and second conductors 102 are inserted into the coupler 170.

A number of couplers 170 may be used to splice multiple conductors 102 in series. For example, a length of the conductor layer 120 from a second end of the second conductor 102 that is opposite the first end of the second conductor 102, and a first end of a third conductor 102 may be removed. The second end of the second conductor 102 is inserted into a channel of a second coupler 170 through a first end of the coupler 170, and a first end of a third conductor 102 is inserted into the channel through a second end of the second coupler 170 that is opposite the first end of the second coupler 170.

Once the conductor(s) 102 are disposed in the coupler 170, the coupler 170 can be crimped, for example, by a crimping apparatus 180 to cause the coupler 170 to be coupled to the conductor 102, for example, coupled to the first and second conductors 102 and to physically and, optionally, electrically couple the first and the second conductors 102. A similar process may be used in which the coupler 170 is a dead end coupler but only the strength member 110 of only one conductor 102 is inserted into the channel defined by the body.

In some embodiments, for example, if the conductor 102 is coupled via forward press crimping (i.e., from the coupler 170 towards the conductor 102), damage may occur to the conductor 102. For example, during forward press crimping, excess material from the coupler 170 or the strength member 110 may migrate from the coupler 170 towards the conductor 102 and become lodged into the conductor 102. This may cause damage to the conductor 102 and/or delamination between the layers of the conductor 102 (e.g., between the strength member 110 and the conductor layer 120) or delamination between the layers of the strength member 110 (e.g., between the core 112 and the encapsulation layer 114). Therefore, to preserve the integrity of the conductor 102 during coupling, it would be advantageous to couple the conductor 102 via backward press crimping such that the excess material migrates away from the conductor 102 and towards the coupler 170. However, as previously described, backward press crimping is generally considered to be dangerous for operators due to backward migration of the excess material, which may cause excess material to break away and the operator, cause overpressure in the coupler thereby damaging the conductor 102 or the coupler 170, and potential explosion of the coupler 170. Hence, backward press crimping with conventional conductors has generally been avoided in the industry, and has also been avoided for conductors including a core encapsulated by one or more other layers (e.g., conductors including a strength member, such as an encapsulated strength member).

In contrast with conventional conductors and the safety issues associated with backward press crimping thereof, embodiments described herein include a coupler 170 having multiple portions or segments, grooves, and/or gaps between the conductor 102 and the coupler 170 (e.g., the dead end) or between a subsequent conductor This may help mitigate safety issues presented by backward press crimping, thereby enabling coupling of conductor 102 and coupler 170 via backward press crimping with minimal damage to the conductor 102 and/or the core 112. This may, for example, facilitate minimal lateral movement of excess materials from crimping to minimize accumulation of excess materials and/or reduce/eliminate build up of pressure in the confined cavity of the coupler.

In some embodiments, the crimping related movement of materials (e.g., migration of excess material) occurs only in a short hollow tube (e.g., the body of the coupler 170). This may enable the field lineman to also easily monitor and manage the excess material movement. This may, for example, reduce or eliminate the risk of pressure building up inside the hollow tube (e.g., the body of the coupler 170) during or after crimping, as the excess material is allowed to move inside the tube, and it is free to come out if needed from the open end (e.g., a two piece coupler) or into openings or grooves defined in at least a portion of the coupler 170.

In some embodiments, the crimped tube (e.g., the body of the coupler 170) can be steel, aluminum, aluminum alloy, or any other suitable metallic tube. After the crimping is done, with the encapsulated core, an eye bolt of the tension hardware, such as in a dead end, can be screwed on or snapped on for ease of installation. The crimped tube (e.g., the body 272) can be the male or the female side for connection with the eyebolt. For ease of installation, it can include a simple rotate and lock in field installation.

In some embodiments, when splicing a conductor 102, to a subsequent conductor (e.g., conductor 102), the two piece coupler approach enables a minor adjustment of the coupler 170 and/or the conductor 102 disposed in the conductor 102. This may, for example, reduce compression forces on the coupler 170 and/or conductor 102, thereby mitigating or avoiding bending of the coupler 170 and/or conductor 102 that can result in a “bow” or banana shape during splicing as the outer fitting sleeve may better move into position for complete fitting installation.

Splicing can also be accomplished with a plurality of pieces for the coupler 170. For example, in some embodiments, the body of the coupler 170 includes two or more pieces, such as three pieces with the middle being the connecting piece for the crimping tubes on both sides of the connecting piece. The plurality of pieces can be screwed together, snap-fit, rotated and click locked, welded, or coupled using any suitable structure or process.

Furthermore, the multi-piece coupler approach also facilitates optical fiber splicing in smart advanced conductor, especially when it is desirable to splice the optical fibers spliced inside the coupler 170.

In some embodiments, the coupler 170, the crimping tube (e.g., the body of the coupler 170), or any of the components or pieces thereof may include one or more grooves or “receding” features (e.g., openings, cavities, axially and/or radially extending channels, helical channels, etc.). In some embodiments, the one or more grooves or receding features can be configured to facilitate a migration of the excess material generated during crimping, for example, radially and/or axially into the coupler 170. In some embodiments, the one or more grooves or “receding features” may be configured to absorb any excess material due to crimping. Furthermore, in some embodiments, the crimping tube or coupler 170 can rotate during fabrication, for example, due to curved and/or spiral grooves defined in an inner surface of the coupler 170 to allow for better gripping and better load transfer between the composite core and the crimped metal tubes for shorter and smaller and lighter fittings.

In some embodiments, the excess material generated during or after crimping may migrate or move. In some embodiments, each iteration of crimping (i.e., each crimp or “bite”) of the encapsulated core (e.g., strength member 110) in a metal tube (e.g., the body of the coupler 170), may generate in a range of 0.1 mm to about 4 mm, inclusive movement of material (e.g., about 0.1, 0.2, 0.3, 0.4, 0.5, 0.6, 0.7, 0.8, 0.9, 1, 1.5, 2, 2.5, 3, 3.5, or 4 mm, inclusive movement of materials). In some embodiments, if performing forward press crimping, i.e., from the dead end or the splicing point, the first bite or crimp may generate about 1 mm of migration or movement of excess material on each side, but the subsequent crimping (with required overlap of ¼″ to ½″) may drive about 2 mm excessive material from the encapsulation layer 114 (e.g., aluminum encapsulation) into the opposite side the conductor (e.g., conductor 102), because the material can only move in one direction.

In some embodiments, an encapsulated core (e.g., the core 112) may utilize about 4-5 crimps for a complete coupling procedure. If coupling via traditional forward press crimping, this could create about 8-10 mm excessive material (i.e., aluminum from the encapsulation layer 114) from each side of crimping that is being pushed into the conductor 102 and/or the core 112. In splicing, with both ends of the conductor 102 receiving such excessive material movement, which can not only damage or destroy the bonding between aluminum encapsulation and the composite core, but may also make the conductor vulnerable to spallation during high temperature operation of the conductor for emergency conditions.

In contrast, during backward press crimping, i.e., starting from the conductor exit/nose area and proceeding toward the dead end or the meeting point of conductors, the movement of materials may be significantly reduced, for example, due to a sloped profile at an exit point of the crimping tube. This may enable minimal movement of excess materials from the encapsulation layer 114 (e.g., aluminum), from the first crimp. The subsequent crimps may, for example, drive excessive material (e.g., excess aluminum from the encapsulation layer 114) to the inside of crimping tube (e.g., the body of the coupler 170), and not into the conductor 102 or core 112. This also reduces or inhibits separation or delamination between the composite core 112 and encapsulation layer 114.

If utilizing the multi-piece coupler approach in conjunction with backward press crimping, it may be possible to preserve the integrity of the strength member 110, such as the bonding between the encapsulation layer 114 and the composite core 112, while substantially reducing or eliminating the risk of bursting of the metal tube (e.g., the body of the coupler 170), and, consequentially thereby eliminating the safety risk to line crew (e.g., technicians, operators, etc.).

In some embodiments, to further improve anti-spallation tendencies in such conductor applications, the surface condition of the conductor 102 and/or coupler 170 can be prepared or optimized (e.g., via dry or wet blasting to promote the bonding between core and the encapsulation layer), as well as other types of aluminum, aluminum alloys with higher compression strength to inhibit and minimize spallation of aluminum encapsulations.

In some embodiments, the coupler 170 may include a coating, for example, disposed on an outer surface of the coupler 170. In some embodiments, the coating on the coupler 170 may be similar to or substantially the same as the outer coating 130, as described herein. In some embodiments, the coating on the coupler 170 may be configured to maintain a temperature of the coupler 170 and/or the assembly 100 in a range of about 60 degrees Celsius to about 250 degrees Celsius, inclusive of all values and ranges therebetween. In some embodiments, the coating on the coupler 170 may be configured to inhibit the temperature of the coupler 170 from exceeding a threshold temperature (e.g., in a range of about 60 degrees Celsius to about 250 degrees Celsius, inclusive). For example, in some embodiments, the coupler 170 may include a high emissivity coating (e.g., emissivity in a range of about) configured to maintain the operational temperature of the coupler 170 and/or the assembly 100 in a desired temperature range (e.g., a range of about 60 degrees Celsius to about 250 degrees Celsius, inclusive).

In some embodiments, the coating of the coupler 170 may include a thermochromic paint configured to change color in response to temperature variations. For example, in some embodiments, in which the conductor 102 is operating at about 200 degrees Celsius, the coupler 170 may be configured to operate at a temperature in a range of about 120 degrees Celsius to about 150 degrees Celsius (e.g., due to heat skin effect due to having higher mass). In some embodiments, the thermochromic paint may be configured to change color when the temperature of the coupler 170 approaches the temperature of the conductor 102 (e.g., about 200 degrees Celsius), which may be indicative of a thermal runaway in the coupler 170. In such a manner, the thermochromic paint on the coupler 170 may be configured enable a user to be made aware of potential safety or operational issues in the coupler 170.

Any suitable crimping apparatus 180 can be used to crimp the conductor 102 to the coupler 170. For example, in some embodiments, the crimping apparatus 180 can include a swage apparatus (hereinafter referred to as “swage apparatus 180”). The swage apparatus 180 can be configured to couple the conductor 102 to the coupler 170. For example, the swage apparatus 180 can be configured to compress or crimp the coupler 170 to the conductor 102. In some embodiments, the swage apparatus 180 may be configured to perform backward press crimping of the coupler 170 to the conductor 102, as described herein.

The swage apparatus 180 is configured to be disposed around the coupler 170 while the conductor is inserted into the channel defined by the coupler 170. In some embodiments, the swage apparatus 180 can be actuated manually or by a power unit to form a compressive force which is transferred to the coupler 170 to be crimped to the conductor 102. For example, the swage apparatus 180 can include a power unit (e.g., an electric motor, battery pack, actuators, etc.) configured to drive the swage apparatus. In some embodiments, the power unit can be pneumatic, hydraulic or electric.

In some embodiments, the swage apparatus 180 includes one or more dies configured to surround the coupler 170 (e.g., configured to be disposed around the coupler 170) and configured exert a uniform and evenly distributed force on an outer surface of the coupler 170 to crimp the coupler 170 to the conductor 102 disposed therein. In some embodiments, the die can include multiple portions (e.g., two portions) between which the coupler 170 can be inserted, for example, to facilitate insertion of the coupler 170 therebetween. The swage apparatus 180—can include a die block configured to transfer the load from the power unit to the die.

In some embodiments, the swage apparatus 180 can include a yoke to connect different dies to provide a uniform crimping of the coupler 170 to the conductor 102. In some embodiments, the swage apparatus 180 can also include a handle that can be engaged by a user, for example, to hold and secure the swage apparatus 180 during operation, or that can be moved by the user from a first position in which a gap exists between inner surfaces of the die (e.g., pieces of the die) and the coupler 170, to a second position that causes the die to move towards the coupler 170 and compress the coupler 170-and crimp it to the conductor 102. In some embodiments, the swage apparatus may have a fluid connector to connect the power unit to the hydraulic pump for transferring the pressure into the power unit.

During swaging or crimping, the compressive which can be built up manually (e.g., via the handle) or through the power unit is converted into a compressive force that can applied to a die block, that can transfer the compressive force to the die. The die crimps the coupler 170 onto the conductor 102. The inward compression transferred from the die to the coupler 170 causes a material flow into the cavity inside the coupler 170. When the coupler 170 is compressed on the conductor 102 are com, the swage or crimping is complete. In some embodiments, the swage apparatus 180 can be configured to facilitate backward press crimping, as described herein. For example, an inner surface(s) of the die of the swage apparatus 180 may be inclined at an angle, define a curvature, and/or include indentations or grooves that cause material flow in a specific direction of the conductor 102 corresponding to backward press crimping. Thus, a user may engage the swage apparatus 180 as normal, and the shape of the die causes backward press crimping without any special maneuvering of the swage apparatus 180.

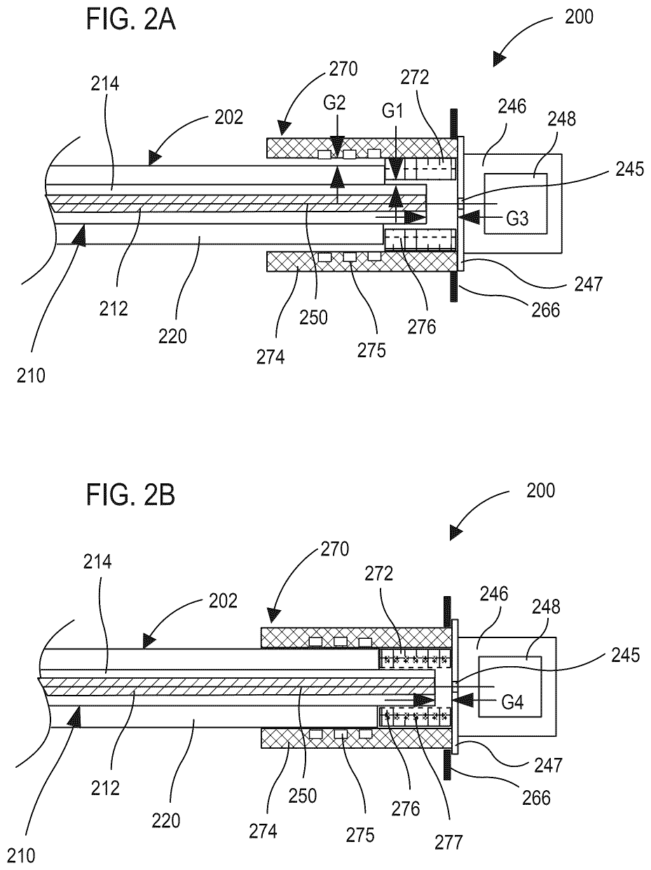

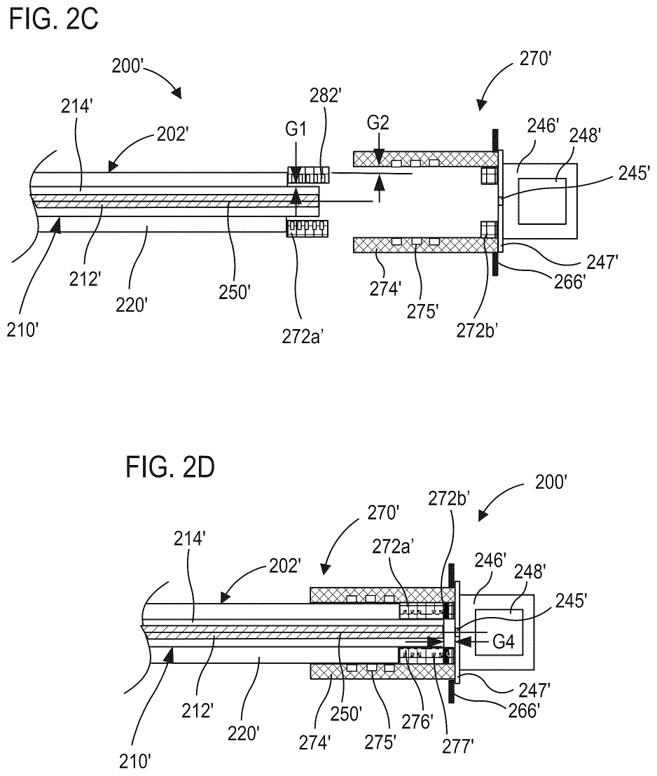

FIGS. 2A-2B are side views of an assembly 200 including a coupler 270 that may be configured to be coupled to an axial end of a conductor 202 using crimping, for example, backward press crimping, according to an embodiment. FIGS. 2C-2D show a side view of an assembly 200′ including a coupler 270′ coupled to an axial end of the conductor 202′ using crimping, for example, backward press crimping, according to an embodiment. The conductor 202′ is substantially similar to the conductor 202. Similarly, the coupler 270′ is substantially similar to the coupler 270 with the difference that the coupler 270′ includes two pieces, as described in further detail herein.

FIG. 2A shows the coupler 270 in an uncoupled configuration in which the conductor 202 is removably disposed in the coupler 270. As shown, the coupler 270 may include a dead end coupler having a connecting portion 246, configured to couple the conductor 202 to a wall 247. The dead end coupler may be coupled to a pole, or tower, or any other suitable coupler as described herein. The conductor 202 can include a strength member 210 and a conductor layer 220 disposed on the strength member 210. The strength member 210 includes a core 212 having an encapsulation layer 214 disposed therearound. In some embodiments, an optical fiber assembly 250 may be disposed in the core 212. The coupler 270 may include a singular body 272, as shown in FIGS. 2A and 2B. On the other hand, the coupler 270′ may include a body 272′ having two body segments or portions 272a′ and 272b′, as shown in FIGS. 2C and 2D. This may, for example, enable an operator to access the optical connector 252 or the optical fiber assemblies 250 in the field without having to decouple the conductors 202. The core 212, 212′, the encapsulation layer 214, 214′, the optical fiber assembly 250, 250′, and the conductor layer 220, 220′ may be substantially similar to the core 112, the encapsulation layer 114, the optical fiber assembly 150, and the conductor layer 120, respectively, and, therefore, some aspects thereof are not described in further detail herein.

While not shown, a coating (e.g., the outer coating 130) may be disposed on an outer surface of the coupler 270 after the coupler 270 has been coupled to the conductor 202 to inhibit a temperature of the core 212 to exceed their glass transition temperature or melting temperature, and/or maintain operating temperature of the conductor layers 220 within a desired range (e.g., between 60 degrees Celsius and 250 degrees Celsius), as previously described herein.

The coupler 270 includes a body 272 (e.g., a cylindrical body) defining a channel therethrough that is configured to receive a portion of an end of the strength member 210 conductor 202. For example, a portion or length of the conductor layer 220 of the conductor 202 may be removed (e.g., a portion having a length in a range of about 150 mm to about 350 mm, inclusive, from the axial end of the conductor 202). The body 272 may be formed from a strong and rigid material. In some embodiments, the body 272 may be formed from a metal or metal alloy, for example, aluminum, alloys, copper, stainless steel, any other suitable material, or any suitable combination thereof. The cross-sectional width (e.g., diameter) of the inner volume of the body 272 may be slightly greater than the cross-sectional width (e.g., diameter) of the strength member 210 such that a first gap G1 exists between an inner surface of the body 272 and an outer surface of the strength member 210 in the uncoupled configuration.

The coupler 270 may also include a sleeve 274 configured to be disposed around the body 272 (e.g., circumferentially around the body 272) and has a length that is longer than a length of the body 272 such that the sleeve 274 extends axially outwards of a first axial end of the body 272 through which the strength member 210 is inserted into the channel defined by the body 272. The sleeve 274 may be formed from a conductive material, for example, aluminum, alloys, copper, stainless steel, any other suitable material, or any suitable combination thereof. The sleeve 274 may have a cross-sectional width (e.g., diameter) that is slightly larger than a cross-sectional width (e.g., diameter) of the conductor layer 220 such that a second gap G2 exists between an inner surface of the sleeve 274 and outer surface of the conductor layer 220 in the uncoupled configuration.

In some embodiments, a third gap G3 may exist between the conductor 202 and the wall 247 or connecting portion 246, in the uncoupled configuration. In some embodiments, the third gap G3 may have a first gap distance, which may be configured to decrease, for example, during or after crimping. The third gap G3 may be configured to receive an excess material generated during a crimping of the coupler 270. Including the third gap G3 in the uncoupled configuration may be advantageous for backward press crimping in which the excess material may migrate from one of the layers of the conductor 202 (e.g., the encapsulation layer 214) towards the third gap G3 such that the third gap G3 receives the excess material. This may, for example, enable safer backward press crimping as the third gap G3 provides a cavity for receiving the excess material without causing an undesired buildup in pressure within the coupler 270 and/or undesired damage to the conductor 202 (e.g., preventing damage to the core 212, the encapsulation layer 214, or a combination thereof) or the coupler 270. The third gap G3 may, for example, enable safer backward press crimping of the coupler 270 to the conductor 202.

In some embodiments, one or more projections (not shown), such as a ledge, may project from an inner surface of the body 272 into the channel defined by the body. The one or more projections may serve as motion limiters to limit movement of the axial end of the conductor 202 into the channel. For example, the axial end of the conductor 202 may be inserted into the body 272 until it contacts the one or more projections. The projections may inhibit further axial motion of the axial end of the conductor 202 such that the gap G3 remains between a back wall 247 of the coupler 270 and the axial end of the conductor 202, when the axial end of the conductor 202 is disposed up to a desired length into the coupler 270

In some embodiments, the coupler 270 may include one or more grooves configured to receive excess material during crimping. For example, as shown in FIG. 2A, the body 272 may include a plurality of grooves 276. The plurality of grooves 276 may be configured to receive excess material during crimping. Each individual groove of the plurality of grooves 276 may include a groove depth, a groove width, and a groove length. In some embodiments, the plurality of grooves 276 may be incorporated in the body 272 radially, axially, or a combination of radially and axially relative to a length of the body 272. This may, for example, enable safer backward press crimping as the plurality of grooves 276 may each provide a cavity for the excess material to be flow into and be disposed in without causing an undesired buildup in pressure within the coupler 270 and/or undesired damage to the conductor 202 (e.g., preventing damage to the core 212, and/or the encapsulation layer 214) or the coupler 270. The plurality of grooves 276 may, for example, enable safer backward press crimping to couple the conductor 202 to the coupler 270.

The coupler 270 also includes a connecting portion 246 coupled to the sleeve 274 and/or the body 272 at a second end of the coupler 270 opposite the first end. For example, a wall 247 of the connecting portion 246 may be coupled to the sleeve 274 and/or the body 272. The connecting portion 246 defines a keyhole 248 configured to couple to corresponding hooks or connectors located on poles (e.g., tension towers) from which the conductor 202 may be suspended. In some embodiments, a protective cap 266 may disposed at the second axial end, at an interface of the sleeve 274 and the connecting portion 246. The protective cap 266 may include a strong and rigid material (e.g., metals, alloys, plastics, polymers, etc.) extending radially from the sleeve 274 and may be configured to absorb a crimping force or direct the force away from the connecting portion 246. In some embodiments, an opening 245 may be defined on the wall 247 of the connecting portion 246 adjacent to the sleeve 274, or any other portion of the coupler 270. The optical fiber assembly 250 included in the conductor 202 may be routed out of the coupler 270 through the opening 245 for coupling with a controller or receiver.

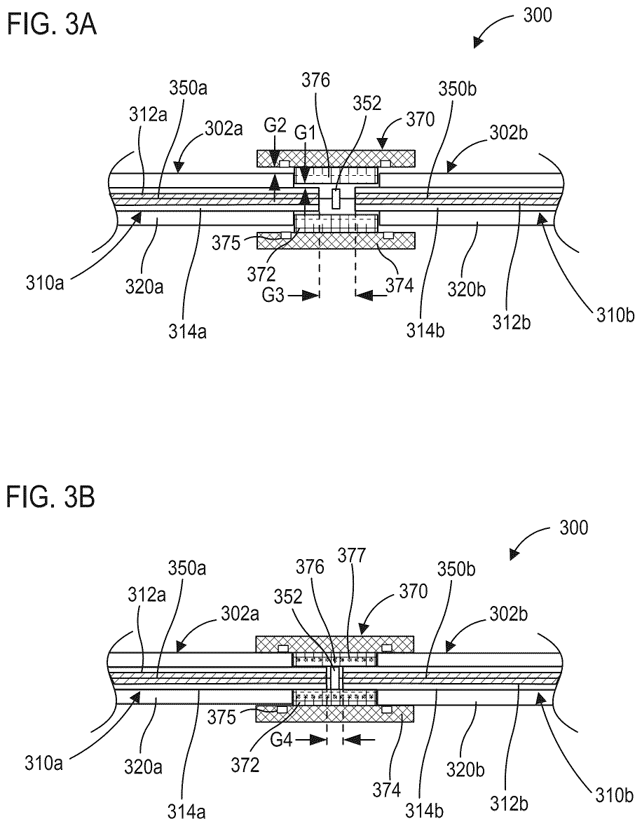

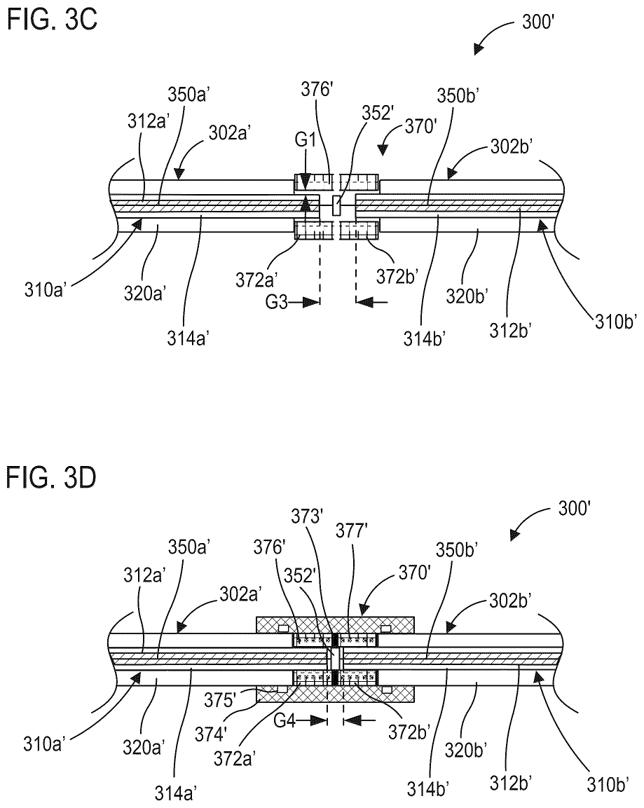

FIG. 2B shows the coupler 270 in a coupled configuration (i.e., a second configuration) in which the coupler 270 is fixedly coupled to the conductor 202, according to an embodiment. In some embodiments, at least one of the first gap G1, the second gap G2, or the third gap G3, as described with respect to FIG. 2A, may be reduced and/or substantially removed during or after coupling. For example, in some embodiments, in the coupled configuration (i.e., after crimping), the first gap G1 may be substantially removed such that at least a portion of the inner surface of the body 272 may contact at least a portion of the outer surface of the encapsulation layer 214. In some embodiments, in the coupled configuration, the second gap G2 may be substantially removed such that a portion of the inner surface of the sleeve 274 may contact a portion of the outer surface of the conductor layer 220. In some embodiments, the third gap G3 may exist between the first conductor 302a and the second conductor 302b in the uncoupled configuration, as shown in FIG. 3A; however, in some embodiments, in the coupled configuration a fourth gap G4 exists between the conductor 202 and the wall 247. As shown, in some embodiments, the fourth gap G4 may be between a first end of the strength member 210 disposed in the coupler 270 and a surface of the wall 247.

In some embodiments, the fourth gap G4 may be smaller than the third gap G3. For example, during or after crimping, the third gap G3 may have received excess material which may have migrated into the gap so as to reduce the third gap G3 having the first gap distance to the fourth gap G4 having a second gap distance smaller than the first gap distance. Including the third gap G3 in the uncoupled configuration may be advantageous for backward press crimping in which the excess material may migrate from one of the layers of the conductors 202 (e.g., the encapsulation layer 214) towards the third gap G3 such that the third gap G3 receives the excess material. This may, for example, enable safer backward press crimping as the third gap G3 and fourth gap G4 may provide for a cavity for the excess material to be disposed without causing an undesired buildup in pressure within the coupler 270 and/or undesired damage to the conductors 202 (e.g., prevent damage to the core 212 or the encapsulation layer 214) or the coupler 270. In some embodiments, the sleeve 274 may also define a plurality of grooves 275, as shown in FIGS. 2A-2B. The plurality of grooves 275 may be configured to receive excess material from the conductor layer 220 during or after crimping to the sleeve 274. Each of the individual grooves 275 of the plurality of grooves 275 may include a groove depth, a groove width, and a groove length, which may be reduced or filled with material from the conductor layer 220 during or after crimping. In some embodiments, the plurality of grooves 275 may be incorporated in the sleeve 274 radially, axially, or a combination of radially and axially relative to a length of the sleeve 274. This may, for example, enable safer backward press crimping of the sleeve 274 in addition to the body 272 as the plurality of grooves 275 may provide a cavity for the excess material from the conductor layer 220 to be disposed in without causing an undesired buildup in pressure within the sleeve 274 of the coupler 270 and/or undesired damage to the conductors 202 (e.g., prevent damage to conductor layer 220) or the coupler 270.

Different from the coupler 270, the coupler 270′may include a plurality of body segments, which when coupled to each other may be substantially similar to the body 272. This may, for example, enable an operator to access the optical connector 252 or the optical fiber assemblies 250 in the field without having to decouple the conductor 202 from the coupler 270 (e.g., the dead end coupler).

For example, as shown in FIGS. 2C and 2D, the coupler 270′ may include a first body segment 272a′ and a second body segment 272b′. In some embodiments, the coupler 270′ may include a spacer 273′. In some embodiments, the uncoupled assembly of FIG. 2C may be substantially similar to the uncoupled configuration as described with respect to FIG. 2A, and, therefore, certain features are not described further herein. Likewise, in some embodiments, the coupled configuration FIG. 2D may be substantially similar to the coupled configuration as described with respect to FIG. 2B, and, therefore, certain features thereof are not described in further detail herein.

As described herein, the first body segment 272a′ is configured to be coupled to the axial end of the strength member 210′ of the conductor 202′ via backward press crimping. Since the end of the first body segment 272a′ is open during crimping, it provides space for the flow of the material from the encapsulation layer generated during crimping, thereby mitigating damage to the first body segment 272a′. Once the first body segment 272a′ is crimped to the axial end of the strength member 210′, the second body segment 272b′ can then be coupled to the first body segment 272a′ (e.g., threaded, welded, bonded, snap-fit, friction fit, or coupled using any suitable coupling method or combination thereof) to fully assemble the coupler 270′. In some embodiments, grooves 275′ may also be defined in the sleeve 274′ and configured to allow flow (e.g., radial and/or axial flow)of excess material from the conductor layer 220′ therein during crimping of the conductor layer 220′ thereto, as previously described with respect to the sleeve 274.

FIG. 3A-3B are side views of a coupler or fitting 370 that may be used to couple an axial end of a first conductor 302a to an axial end of a second conductor 302b (i.e., splicing conductors 302a and 302b) using crimping, for example, backward press crimping, to form an assembly 300, according to an embodiment. FIGS. 3C-3D are side view of a coupler or fitting 370′ that may be used to couple an axial end of a first conductor 302a′ to a second conductor 302b′, according to another embodiment. The first conductors 302a and 302a′ are substantially similar each other, and the second conductors 302b and 302b′ are substantially similar to each other. In addition, the coupler 370′is substantially similar to coupler 370 with the difference that the coupler 370 is single piece coupler, while the coupler 370′ is a two piece coupler.

FIG. 3A shows the coupler 370 in an uncoupled configuration in which the first and second conductors 302a, 302b are removably disposed in the coupler 370. FIG. 3B shows the coupler 370 in a coupled configuration in which the first and second conductors 302a, 302b are fixedly coupled to the coupler 370. The conductors 302a, 302b can be substantially similar to each other, and include a strength member 310a, 310b and a conductor layer 320a, 320b disposed on the strength member. The strength member 310a, 310b includes a core 312a, 312b having an encapsulation layer 314a, 314b disposed therearound. An optical fiber assembly 350a, 350b may be disposed in the core 312a, 312b. In some embodiments, the coupler 370 may include a singular body 372, as shown in FIGS. 3A and 3B The core 312a, 312b, the encapsulation layer 314a, 314b, the optical fiber assembly 350a, 350b, and the conductor layer 320a, 320b may be substantially similar to the core 112 or 212, the encapsulation layer 114 or 214, the optical fiber assembly 150 or 250, and the conductor layer 120 or 220, respectively, and, therefore, some aspects are not described in further detail herein.

As shown in FIG. 3A, the coupler or fitting 370 includes a body 372 (e.g., a cylindrical body) defining a channel configured to receive portions of corresponding axial ends of the first strength member 310a and the second strength member 310b. For example, a predetermined length of the conductor layers 320a, 320b of the conductors 302a, 302b may be removed (e.g., a portion having a length in a range of about 150 mm to about 350 mm, inclusive from the axial end of the conductors 302a, 302b). The body 372 may be formed from a strong and rigid material. In some embodiments, the body 372 may be formed from a metal or metal alloy, for example, aluminum, alloys, copper, stainless steel, any other suitable material, or any suitable combination thereof. The cross-sectional width (e.g., diameter) of the inner volume of the body 372 may be slightly greater than the cross-sectional width (e.g., diameter) of the strength members 310a, 310b such that a first gap G1 exists between an inner surface of the body 372 and an outer surface of the strength members 310a. 310b in the uncoupled configuration. In some embodiments, an optical connector 352 (e.g., any of the optical connectors as described with respect to assembly 100) is disposed in the channel. Each of the optical fiber assemblies 350a, 350b may be coupled to the optical connector 352 to optically couple the optical fiber assemblies 350a, 350b to each other.

The coupler 370 also includes a sleeve 374 configured to be disposed around the body 372 (e.g., circumferentially around the body 372) and has a length that is longer than a length of the body 372 such that the sleeve 374 extends axially outwards of the body 372. The sleeve 374 may be formed from a conductive material, for example, aluminum, alloys, copper, stainless steel, any other suitable material, or any suitable combination thereof. The sleeve 374 may have a cross-sectional width (e.g., diameter) that is slightly larger than a cross-sectional width (e.g., diameter) of the conductor layers 320a, 320b such that a second gap exists between an inner surface of the sleeve 374 and outer surface of the conductor layers 320a, 320b in the uncoupled configuration.

In some embodiments, a third gap G3 may exist between the first conductor 302a and the second conductor 302b in the uncoupled configuration. As shown, in some embodiments, the third gap G3 may be between the first end of the strength member 310a and the first end of the strength member 310b. In some embodiments, the third gap G3 may have a first gap distance, which may be configured to decrease, for example, during or after crimping. The third gap G3 may be configured to receive an excess material generated during a crimping of the coupler 370. Including the third gap G3 in the uncoupled configuration may be advantageous for backward press crimping in which the excess material may migrate from one of the layers of the conductors 302a, 302b (e.g., the encapsulation layers 314a, 314b) towards the third gap G3 such that the third gap G3 receives the excess material. This may, for example, enable safer backward press crimping as the third gap G3 may provide a cavity for the excess material to be disposed in without causing an undesired buildup in pressure within the coupler 370 and/or undesired damage to the conductors 302a, 302b, the coupler 370. The third gap G3 may, for example, enable safer backward press crimping of the coupler 370 to the conductors 302a, 302b.

In some embodiments, one or projections (not shown) may project from an inner surface of the body 372 into the channel defined by the body 372. The one or more projections may serve as motion limiters to limit movement of the axial ends of the conductors 302a, 302b into the channel. For example, the axial end of the conductors 302a, 302b may be inserted into the body 372 until they contact opposing surface of the one or more projections, and a gap remains therebetween. Excess material flow from the encapsulation layers 314a, 314b during backward flow crimping may flow into and accommodate into the gap, thus inhibiting damage to the coupler 370.

In some embodiments, the coupler 370 may include one or more grooves configured to receive excess material during crimping. For example, as shown in FIG. 3A, the body 372 may include a plurality of grooves 382 defined on an inner surface thereof. The plurality of grooves 382 may be configured to receive excess material radially and/or axially during crimping. Each of the individual grooves of the plurality of grooves 382 may include a groove depth, a groove width, and a groove length. In some embodiments, the plurality of grooves 382 may be incorporated in the body 372 radially, axially, or a combination of radially and axially relative to a length of the body 372. This may, for example, enable safer backward press crimping as the plurality of grooves 382 may each provide for a cavity for the excess material to be disposed in without causing an undesired buildup in pressure within the coupler 370 and/or undesired damage to the conductors 302a, 302b, or the coupler 370. The plurality of grooves 382 may, for example, enable safer backward press crimping of the coupler 370 to the conductors 302a, 302b.

In some embodiments, the sleeve 374 may also define a plurality of grooves 375, as shown in FIGS. 3A-3B. The plurality of grooves 375 may be configured to receive excess material from the conductor layers 320a, 320b during or after crimping to the sleeve 374. Each of the individual grooves 375 of the plurality of grooves 375 may include a groove depth, a groove width, and a groove length, which may be reduced or filled with material from the conductor layers 320a, 320b during or after crimping. In some embodiments, the plurality of grooves 375 may be incorporated in the sleeve 374 radially, axially, or a combination of radially and axially relative to a length of the sleeve 374. This may, for example, enable safer backward press crimping of the sleeve 374 in addition to the body 372 as the plurality of grooves 375 may provide a cavity for the excess material from the conductor layers 320a, 320b to be disposed in without causing an undesired buildup in pressure within the sleeve 374 of the coupler 370 and/or undesired damage to the conductors 302a, 302b (e.g., prevent damage to conductor layers 320a, 320b) or the coupler 370.

FIG. 3B shows the coupler 370 in a coupled configuration after crimping the coupler to conductors 302a, 302b, according to an embodiment. In some embodiments, the sleeve 374 may be crimped to corresponding portions of the conductor layers 320a, 320b, and the body 372. This couples the coupler 370 to corresponding axial ends of the conductors 302a, 302b, thus physically coupling the conductors 302a, 302b, and electrically coupling the conductor layers 320a, 320b. As previously described, the composite material from which the core 312a, 312b is formed may be susceptible to crush force damage. However, the encapsulation layers 314a, 314b disposed around the cores 312a, 312b also serve as protection layers to protect the cores 312a, 312b from the compressive force exerted during coupling of the body 372a, 372b around the strength members 310a, 310b. Moreover, the first optical fiber assembly 350a may be coupled to the second optical fiber assembly 350b, for example, via the optical connector 352. In this manner, the first optical fiber assembly 350a may communicate sensing signals measured by the first optical fiber assembly 350a to the second optical fiber assembly 350b or vice versa for eventual communication to a controller. While not shown, a coating (e.g., the outer coating 130) may be disposed on an outer surface of the coupler 370 after the coupler 370 has been coupled to the conductors 302a, 302b to inhibit a temperature of the core 312a, 312b to exceed their glass transition temperature or melting temperature, and/or maintain operating temperature of the conductor layers 320a, 320b within a desired range (e.g., between 60 degrees Celsius and 250 degrees Celsius), as previously described herein.

In some embodiments, at least one of the first gap G1, the second gap, or third gap G3, as described with respect to FIG. 3A, may be reduced and/or substantially removed during or after coupling. For example, in some embodiments, in the second configuration (i.e., after crimping), the first gap G1 may be substantially removed such that at least a portion of the inner surface of the body 372a, 372b may contact at least a portion of the outer surface of the encapsulation layer 314a, 314b. In some embodiments, in the second configuration, the second gap may be substantially removed such that a portion of the inner surface of the sleeve 374 may contact a portion of the outer surface of the conductor layer 320a, 320b. In some embodiments, the third gap G3 may exist between the first conductor 302a and the second conductor 302b in the uncoupled configuration, e.g., between the first axial end of the first conductor 302a and the first axial end of the second conductor 302b, as shown in FIG. 3A. In some embodiments, in the second configuration a fourth gap G4 exists between conductors 302a and 302b, e.g., between the first axial end of the first conductor 302a and the first axial end of the second conductor 302b, as shown in FIG. 3B. In some embodiments, the fourth gap G4 may be smaller than the third gap G3. For example, during or after crimping, the third gap G3 may have received excess material which may have migrated into the gap so as to reduce the third gap G3 having the first gap distance to the fourth gap G4 having a second gap distance smaller than the first gap distance. Including the third gap G3 in the uncoupled configuration may be advantageous for backward press crimping in which the excess material may migrate from one of the layers of the conductors 302a, 302b (e.g., the encapsulation layers 314a, 314b) towards the third gap G3 such that the third gap G3 receives the excess material. This may, for example, enable safer backward press crimping as the third gap G3 and fourth gap G4 may provide a cavity for the excess material to be disposed in without causing an undesired buildup in pressure within the coupler 370 and/or undesired damage to the conductors 302a, 302b, the coupler 370.

Referring to FIGS. 3C and 3D, the coupler 370 may include a first body segment 372a′ and a second body segment 372b′. As described herein, the first body segment 372a′ is configured to be coupled to the axial end of the first strength member 310a′ of the first conductor 302a′ via backward press crimping. Similarly, the second body segment 372b′ is configured to be coupled to the axial end of the second strength member 310a′ of the second conductor 302a′ via backward press crimping. Since the ends of the first and second body segments 372a′ and 372b′ are open during crimping, there is space for the flow of the material from the encapsulation layer generated during crimping to flow, thereby mitigating damage to the first and second body segments 372a′ and 372b′. The second body segment 372b′ can then be coupled to the first body segment 372a′ (e.g., threaded in, welded, bonded, snap-fit, friction fit, or coupled using any suitable coupling method or combination thereof) to fully assemble the coupler 370′. In some embodiments, a coupler (e.g., a nut) may be disposed between the first and second body segments 372a′ and 372b′ to facilitate coupling thereof. In some embodiments, the two piece splicing coupler 370a′ may also facilitate coupling of the optical fiber assemblies 350a′ and 350b′ to each other.

In some embodiments, grooves 375′ may also be defined in the sleeve 374′ and configured to allow flow (e.g., radial and/or axial) flow of excess material from the conductor layer 230′ therein during crimping of the conductor layer 320′thereto, as previously described with respect to the sleeve 374.

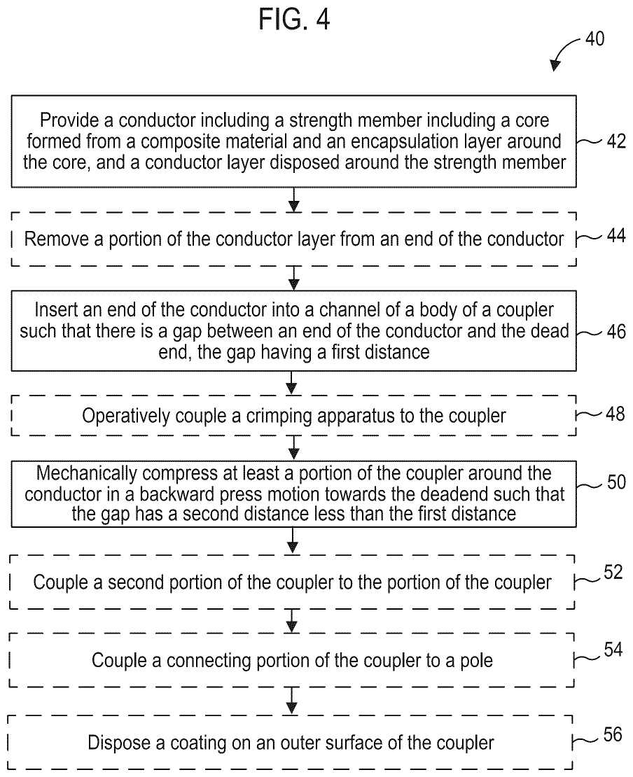

FIG. 4 is a schematic flow chart of a method 40 for coupling a conductor (e.g. the conductor 102, 202, 202′) to a coupler (e.g., the coupler 170, 270, 270′) using crimping, according to an embodiment. While described with respect to the conductor 202, 202′ and the coupler 270, 270′, the operations of the method 40 can be used to couple any conductor to any coupler using crimping. All such implementations are envisioned and should be considered to be within the scope of the present disclosure.

The method 40 includes providing the conductor 202, 202′, at 42. At 44, a portion or length of the conductor layer 220, 220′ is removed from an end of the conductor 202, 202′ to expose a portion of the strength member 210, 210′ of the conductor 202, 202′ (e.g., a portion having a length in a range of about 150 mm to about 350 mm, inclusive, from the end of the conductor 202, 202′). For example, a circumcizer, a cutter or any other suitable equipment may be used to make slits or cuts in the conductor layer 220, 220′ of the conductor 202, 202′ proximate to an end of the conductor 202, 202′ and the portion of the conductor layer 220, 220′ of the conductor 202, 202′ to expose a portion of the strength member 210, 210′ thereof.

At 46, the end of the conductor 202 is inserted into a channel defined by the coupler 270 through a first end of the coupler 270 such that there is a gap between an end of the conductor 202 (e.g., an axial end of the strength member 210) and a dead end (e.g., the wall 247 or the connecting portion 246), the gap having a first distance. For example, the exposed portion of the strength member 210 is inserted into a channel defined by the body 272. In some embodiments, the coupler 270 also includes the sleeve 274 such that inserting the exposed portion of the strength member into the channel defined by the body 272 also inserts a corresponding portion of the conductor layer 220 into a first end of the sleeve 274. In some embodiments, a mark or indicator may be provided or formed on an outer surface of the conductor layer 220 and the mark aligned with an outer edge of the first end of the sleeve 274 such that the conductor 202 is inserted only up to a predetermined length into the coupler 270. In some embodiments, when the coupler 270′ is used, the end of the conductor 202 is inserted into the first body segment 272a′, as previously described.

In some embodiments, positioning the exposed portion of the strength member 210 of the conductor 202 within a portion of the channel defined by the body 272 of the coupler 270 disposes the conductor layer 220 of the conductor 202 in a portion of the coupler 270 that is outside the body 272 but within the sleeve 274 of the coupler 270. In some embodiments, the body 272 and the sleeve 274 have inner cross-sectional widths (e.g., diameters) that are larger than corresponding outer cross-sectional widths of the strength member 210 and the conductor layer 220 of the conductor 202. This allows a gap to be present between inner surfaces of the body 272 and the sleeve 274 and corresponding outer surfaces of the strength member 210 and the conductor layer 220 when the conductor 202 is inserted into the coupler 270.

In some embodiments, a crimping apparatus is operatively coupled to the coupler 270, at 48. Any suitable crimping apparatus may be used such as, for example, an apparatus configured to mechanically compress at least a portion of the coupler 270, 270′ around the conductor 202, 202′. In some embodiments, the crimping apparatus may include the swage apparatus 180, as previously described herein.

At 50, the coupler 270, or the first body segment 272a′ is mechanically compressed (e.g., crimped) to cause the coupler 270 to be coupled to the conductor 202, or the first body segment 272a to the conductor 202′. For example, in some embodiments, at least a portion of the coupler 270, first body segment 272a′ is crimped around the conductor 202, 202′ in a backward press motion from proximate the conductor 202, 202′ towards the dead end (e.g., the wall 247 or the connecting portion 246), or towards a distal end of the first body segment 272a′. In some embodiments, this may reduce or eliminate the gap between the axial end of the conductor 202 and the dead end (e.g., the gap between the axial end of the strength member 210 and the wall 247 or the connecting portion 246) such that the gap has a second gap distance that is less than the first gap distance.

In some embodiment when the coupler 270′ is used, the second body segment 272b′ may be coupled to the first body segment 272a′, at 52, as previously described herein. In some embodiments, the connecting portion 246, 246′ of the coupler 270, 270′ may be coupled to a pole (e.g., an electrical pole or tower), at 54. For example, a hook, rope, coil, or any other coupling mechanism may be interfaced with the keyhole 248 defined in the connecting portion 246 to couple the coupler 270 to the pole. In some embodiments, the method 40 may also include disposing a coating, for example, the coating 130 on the outer surface of the coupler 270, at 56.

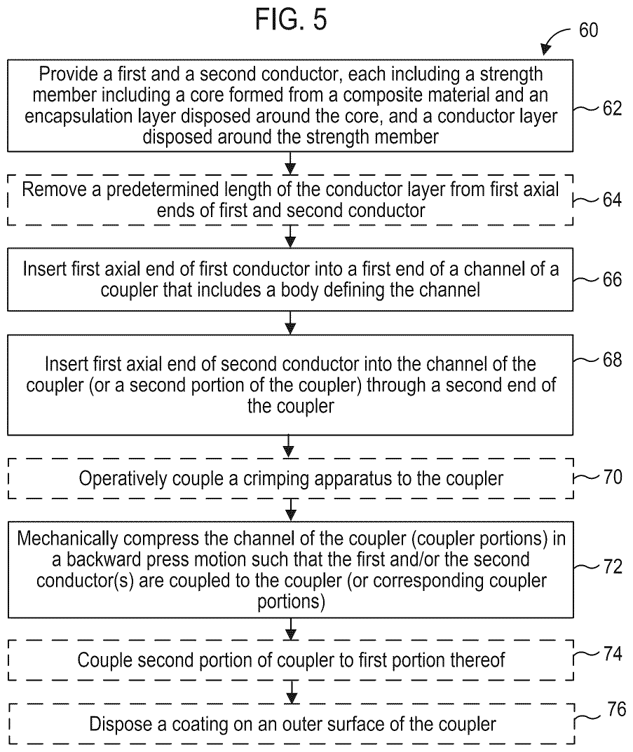

FIG. 5 is a schematic flow chart of a method 60 for coupling a first conductor (e.g., the conductor 102, 302a, 302a′) to a second conductor (e.g., the conductor 102, 302b, 302b′) via a coupler (e.g., the coupler 170, 370, 370′) using crimping, according to an embodiment. While described with respect to the conductors 302a, 302b, 302a′, 302b′, and the coupler 370, 370′ the operations of the method 60 can be used to couple or splice any conductors described herein via the coupler 170, 370, 370′.

The method 60 includes providing the first conductor 302a, 302a′ and the second conductor 302b, 302b′, at 62. The method 60 includes removing a portion or length of the conductor layer 320a, 320b, 320a′ 320b′ from first ends of each of the first conductor 302a, 302a′ and the second conductor 302b, 302b′ to expose a portion of the respective strength members 310a, 310a, 310b, 310b′ of the first and second conductors 302a, 302a′, 302b, 302b′ at 64 (e.g., removing a portion having a length in a range of about 150 mm to about 350 mm, inclusive, from the axial end of the conductors 302a, 302a′, 302b, 302b′), as previously described.

At 66, the first end of the first conductor 302a is inserted into a channel defined by the body 372 of the coupler 370 through a first end of the coupler 370. When the coupler 370′ is used, operation 66 can include inserting first end of the first conductor 302a′ into the first body segment 372a′.

At 68, a first end of the second conductor 302b is inserted into the channel of the coupler 370 through a second end of the coupler 370 opposite the first end. In some embodiments, there is a gap between the first axial end of the first conductor and the first axial end of the second conductor, the gap having a first distance. When the coupler 370′ is used, operation 68 can include inserting first end of the second conductor 302b′ into the second body segment 372b′. In some embodiments, the optical connector 352 may be disposed into the channel defined by the coupler 370, for example, within the channel defined by the body 372. First ends of the optical fiber assembly 350a, 350b of each of the first and second conductors 302a, 302b may be exposed and inserted into the optical connector 352 or otherwise communicatively coupled thereto, to optically couple the optical fiber assembly 350a of the first conductor 302a to the optical fiber assembly 350b of the second conductor 302b. When coupler 370′ is used, the optical connector 352 may be disposed in either one of the first or second body segments 372a′ or 372b′, or the optical connector 352′ may be provided separately and configured to be disposed between the two segments 372a′ and 372b′ (e.g., partially in each of the segment 372a′ and 372b′) so as to be secured within the two segments 372a′ and 372b′ once they are coupled to each other. In such embodiments, the first ends of one the optical fiber assembly 350a′, 350b′ that is first crimped to its corresponding body segment 372a′, 372b′ may initially be coupled to the optical connector 352′ and other of the two coupled subsequently before coupling the two segments 372a′ and 372b′ together, as described herein.

In some embodiments, inserting the first ends of the first and second conductors 302a, 302b includes inserting the exposed portions of the first and second strength members 310a, 310b within a portion of the channel defined by the body 372 of the coupler 370 such that corresponding axial ends of the conductor layers 320a, 320b of each of the first and second conductors 302a, 302b are positioned in a portion of the coupler 370 that is outside the body 372, for example, but within the sleeve 374 of the coupler 370. In some embodiments, the body 372 and the sleeve 374 have inner cross-sectional widths (e.g., diameters) that are larger than corresponding outer cross-sectional widths of the strength members 310a, 310b and the conductor layers 320a, 320b of the first and second conductors 302a, 302b. This allows a gap to be present between inner surfaces of the body 372 and the sleeve 374 and corresponding outer surfaces of the strength members 310a, 310b and the conductor layers 320a, 320b when ends of the first and second conductors 302a, 302b are inserted into the coupler 370.

In some embodiments, a crimping apparatus is operatively coupled to the coupler 370 or independently to first body segment 372a′ or 372′ of the coupler 370′, at 70. Any suitable crimping apparatus may be used such as a swaging device.

At 72, the coupler 370 (or first and/or second body segments 372a′ and 372b′) is mechanically compressed (i.e., crimped) to cause the coupler 370 to be coupled to the first and second conductors 302a, 302b (or first body segment 372a′ to the first conductor 302a′ and the second body segment 372b′ to the second conductor 302b′), and to electrically couple the first and the second conductors 302a, 302b to each other, as previously described. In some embodiments, the coupler 370 disposed around the first conductor 302a and the second conductor 302b may be crimped simultaneously. Thus, any suitable number of couplers can be crimped simultaneously, allowing conductors to be coupled to each other via their respective couplers simultaneously, as previously described. In some embodiments, when the coupler 370′ is used, the first body segment 372a′ is coupled to the second body segment 372b′ to couple the first conductor 302a′ to the second conductor 302b′, at 74, as described herein.

In some embodiments, the method 60 may also include disposing a coating, for example, the coating 130 disposed on the outer surface of the coupler 370a, 370a′, at 76, as previously described.

In some embodiments, the conductor splicing, especially for splicing the conductor layer (e.g., aluminum strands) to aluminum sleeve, can be achieved by crimping in one direction, i.e., one side of aluminum crimping being backward press (toward and onto the center of the coupler), and the other side being forward press (toward and onto conductor). This may, for example, avoid possible stretching on the crimped strength member, due to the excess material movement from aluminum sleeve crimping. The aluminum sleeve can be made or substituted with aluminum alloy or other conductive metals.

Furthermore, the aluminum sleeve can be multiple pieces, with an inner small and shorter tube inside the long and big outer aluminum sleeve. This facilitates easy movement and slide in for the crimped steel tube on strength member, even when there is ‘banana shape’ developing in the steel tube after crimping, as the insertion of the smaller aluminum tubes can be easily made from both ends of the coupler, while the crimped steel tube can slide into the larger outer tube with ease. The secondary aluminum tubes can be easily tailored for different conductor types, while reuse the same larger outer aluminum sleeve for manufacturing inventory and cost control. The aluminum sleeve or tubes can be made or substituted with aluminum alloys or other conductive metals.

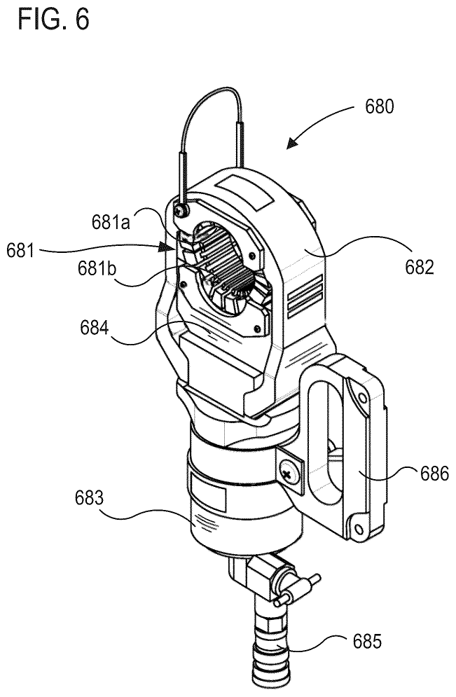

FIG. 6 is an illustration of an example of a swage apparatus 680 that can be used to couple a coupler (e.g., the coupler 170) to any of the conductors (e.g., the conductor 102) described herein, according to an embodiment. Swage apparatus' are generally used to shape or form material, usually metals, by applying an impact, compressive force, or pressure on the components to be coupled. The process of swaging is where the shape of the material is altered by squeezing or compressing it via a die. The swage apparatus 680 can be used to taper or reduce the diameter of a tube or pipe for example to form flared ends for fittings or joining tubes, and particularly, for crimping any of the couplers described herein to the conductors described herein. In some embodiments, the swage apparatus 680 may include a die 681 including a first portion 681a and a second portion 681b, a die block 684 and a power unit 683. The swage apparatus 680 may further include a handle 686, a yoke 682 and a fluid connector 685. In some embodiments, the swage apparatus 680 may include a quick release endplate to facilitate rapid changes of die sizes.

In some embodiments, the power unit 683 may be responsible for providing the necessary force to operate the swage apparatus 680. The power unit 683 may include any suitable power transmission mechanism including, for example, electric, hydraulic, mechanical, manual, and/or pneumatic press. The power unit 683 may be configured to cause movement of the die portions 681a and/or 681b at a consistent speed or force to provide consistent pressure, speed, and efficiency of the swaging process to enable consistent crimping of couplers to conductors.

In some embodiments, the handle 686 may be configured to engaged by a user to hold the swage apparatus 680 during a swaging operation. In some embodiments, the sage apparatus can be manually operated. In such embodiments, the power unit 683 may be replaced by the handle 686 or lever, that can be operatively coupled to the first and/or second die portions 681a, 681b. The handle 686 may be engageable by the user to selectively move the die portions 681a, 681b towards each other to crimp a coupler disposed therebetween to a conductor disposed in the coupler, as previously described herein. In some embodiments, the manual swage apparatus 680 may use a ram or punch to deliver forces to the assembly for compression.

In some embodiments, the handle 686 or lever arm can be sufficiently long to provide sufficient torque to reduce force applied by the user to perform a swaging operation. The mechanical press mechanism may be used for higher speed production while hydraulic press (e.g., actuated by the power unit 683) may be more suitable for higher precision and force. Hydraulic press mechanism can be advantageous because it can include wireless actuation where the pump and operator are far apart from each other. In some embodiments, the swage apparatus 680 may include a hydraulic press mechanism. In such embodiments, the swage apparatus 680 may include the fluid connector 685 that may be configured to connected to the power unit 683, and configured to couple to a hose that transfers pressure from a pump to the power unit 683. The power unit 683 may be configured to pressurize the hydraulic fluid and build up pressure in the hydraulic fluid. The hydraulic pressure can be converted into a compressive force that is applied to the die block 684 and therefrom, the dies 681a, 681a, for example, via a piston in the power unit 683.

In some embodiments, the swage apparatus 680 may be a power apparatus including the power unit 683, but may further include the handle 686, that may be mounted on or proximate to the power unit 683. The handle 686 may be used to hold the swage apparatus 680 and insert the assembly of the conductor 202 and the coupler 270, or any other coupler or conductor into the swage apparatus 680. In some embodiments, the handle 686 can be a rotating handle which can be quickly removed or repositioned in a more desirable orientation depending on the environment.

The swage apparatus 680 may further include the yoke 682 that connects to the power unit 683 and holds the first die 681b and second die 681a in place. The yoke 682 opposes the force exerted by die block 684. The yoke 682 may be used to provide stability when swaging large diameter conductors. The yoke 682 may further function to distribute and transfer the mechanical forces to the die pieces and maintain proper alignment of portions of the die 681a and 681b.

The swage apparatus 680 may further include the die block 684. The die block 684 may serve as a mounting platform or housing for the load transfer mechanism which transfers the load to the die to compress the coupler (e.g., the coupler 270) onto the conductor (e.g., the conductor 202) to crimp the coupler to the conductor. The die block 684 holds the first die 681b that contacts the second die 681a and may provide a secure and stable surface for pressing and preventing movement during crimping. The die block 684 may ensure a uniform deformation and flow of the material by distributing the pressure evenly over the coupler surface. The die block 684 may further transfer the load exerted by the power unit 683 into the second die 681b and the first die 681a. The die block 684 can be formed from a strong and rigid material such as, for example, stainless steel, hardened steel, tungsten carbide, any other suitable material or combination thereof, s to withstand high pressure and wear. The die block 684 be open or closed with different cavity shapes to accommodate various dies having different shapes and/or sizes. In some embodiments, the die block 684 can be polished, lubricated, or coated with a smoothing material, or include channels to reduce friction and/or prevent damage to the die block 684 during operation reduce wear, and/or increase life.

In some embodiments, the die 681 include two portions or pieces, the first portion 681a and the second portion 681b, as shown in FIG. 6. The die portions 681a, 681b can be held together by the yoke 682, that may be removably coupled to the die block 684, for example, to define a cavity, recess, or otherwise space for receiving an securing the die portions 681a, 681b. The die 681 may be a precision-machined metal insert designed to apply pressure to compress and shape material. The die 681 may be configured or selected to match a size and/or shape of the coupler, and/or the conductor.

The die 681 can be interchangeable, stationery, or movable, and can be formed from any suitable strong, rigid, and durable material that is resistant to wear (e.g., stainless steel, hardened steel, tungsten carbide, alloys, ceramics, etc.). The die 681 may close around the conductor (e.g., the conductor 202) inserted into the coupler (e.g., the coupler 270) and crimp the coupler to the conductor. The first die 681a and the second die 681a may be the components that come into contact with the coupler to ensure a secure and even transfer of load on the coupler for compressing the coupler to the conductor. The first die 681a and the second die 681b convert the force from the power unit 683 into a 360° radial swage on the coupler. The die 681 may have curved crimping surfaces, a single machined slot, or multiple machined slots, for example, to provide a precise groove design to ensure consistent compression. In some embodiments, the die 681 can be configured to leave an imprinted design or mark on the swaged conductor for future identification of crimping tools. In some embodiments, the die 681 can have polished or smooth surface to prevent damage to the coupler. In some embodiments, the die 681 can be coated with a corrosion resistant material, for example, nitride, black oxide, TEFLON®, ceramics, etc.

The swage apparatus 680 may further include the fluid connector 685 which may be configured to connect to the power unit 683 to a pneumatic or hydraulic source and facilitate fluid communication from the source to the power unit 683. In some embodiments, the fluid connector 685 may be configured to be coupled to a hose or conduit that communicates the pneumatic fluid (e.g., air, nitrogen, etc.) or hydraulic fluid (e.g., oil) to the power unit 683 for powering the swage apparatus 680. During swaging, the assembly of the conductor and the coupler may transition from an uncoupled configuration to a coupled configuration. The swaging process may start with selecting the right die size for the die portions 681a and/or 681b, and secure insertion of the second die 681b into the die block 684 as well as inserting the first die 681a into the yoke 682. The swage apparatus 680 may be disposed around the coupler with axial end of the conductor disposed therein, for example, between the die portions 681a and 681b.

In the uncoupled configuration, the conductor is removably disposed in the coupler, and the swage apparatus 680 is disposed over the coupler such that there is a gap between at least one of the first die 681a or the second die 681b, a and the coupler. There may also be a gap between an inner surface of the coupler and an outer surface of the conductor in the uncoupled configuration. To couple the coupler to the conductor, a user may activate the swage apparatus 680, for example, by activating the power unit 683 or engaging the handle 686, causing the first die portion 681a and/or the second die portion 681b towards the other, or towards each other. This causes the die portions 681a, 681b to apply a compressive force on the coupler causing the coupler to undergo mechanical deformation and be crimped to the conductor, thus transitioning the coupler and conductor to a coupled configuration. In the coupled configuration, the conductor 202 is coupled with the coupler 270 and the gap between the coupler and the conductor is substantially reduced or removed.

Expanding further, activation of the power unit 683 or engagement of the handle 686 may cause pressure build up in the power unit 683 that is converted into a compressive force that is applied to the die block 684. The die block 684 transfers the load to the second die 681b. In this example, the second die 681b is restrained from moving by the yoke 682 such that an opposing force is applied on the outer surface of the coupler to compress the coupler and crimp it to the conductor via plastic deformation of the coupler. In some embodiments, the swaging process causes the coupler material to flow toward the gap between the conductor and coupler without causing an undesired pressure buildup within the coupler 270 and/or undesired damage to the conductor or the coupler. In some embodiments, the swage apparatus 680 can be configured to cause backward press crimping of the coupler to the conductor. The backward press crimping can embed the conductor into a sleeve (e.g., the sleeve 274) of the coupler and form a high strength mechanical bond that may exceed the conductor's own tensile strength. In some embodiments, this process occurs below a recrystallization temperature of the coupler and/or the conductor, which can increase the hardness and/or strength of the crimped portion of the coupler and/or conductor. The swaging process may further be inspected after the release of the swage tool from the crimped assembly 200. In some embodiments, the swaging process may be repeated several times to achieve the desired compression.

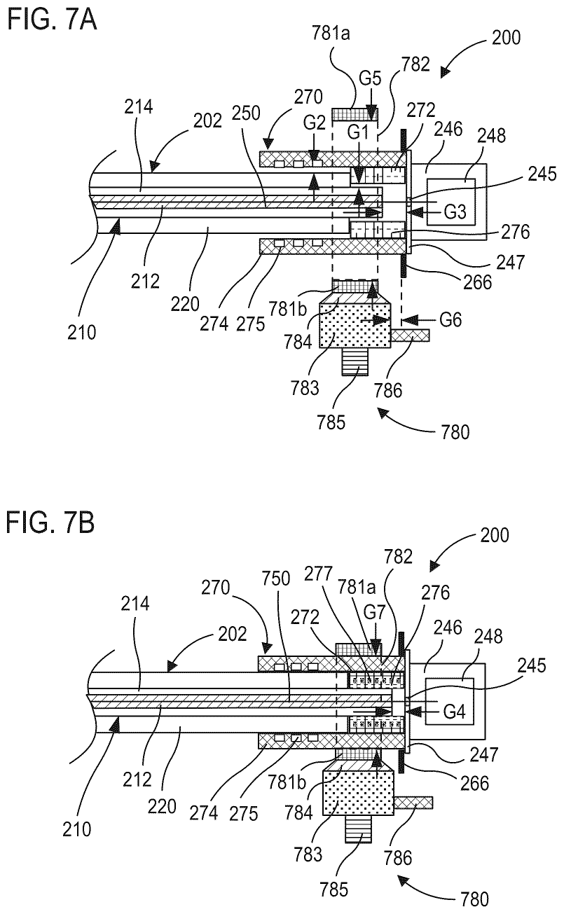

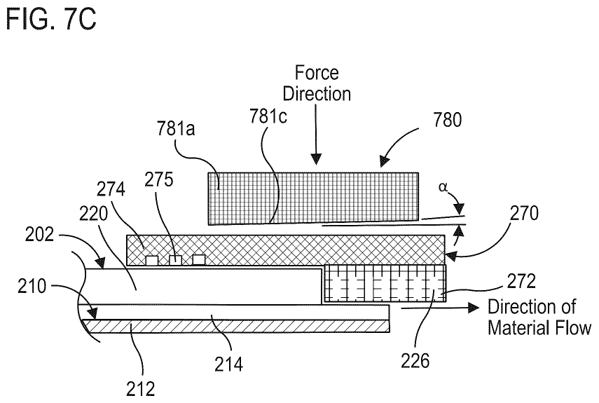

FIGS. 7A-7B are side views of the assembly 200 including the coupler 270 that may be configured to be coupled to an axial end of the conductor 202 using a swage apparatus 780 via backward press crimping, according to an embodiment. The conductor 202 and the coupler 270 are described herein in detail with respect to FIGS. 2A-2B, and therefore the components are not described in further detail here. The coupler 270 may include a dead end coupler having a connection portion 246, configured to couple the conductor 202 to the wall 247. It can further include a body 272 that is configured to receive a portion of the strength member 210 during the swaging process. The coupler 270 may include a plurality of grooves 276 incorporated in the body 272. The coupler 270 may further include a plurality of grooves 275 incorporated in the sleeve 274. These grooves provide enough space for flow of excess material and enable safer backward press crimping without any damage to the conductor 202 or the coupler 270, as previously described herein. FIG. 7A shows the coupler 270 and the conductor 202 in an uncoupled configuration in which the conductor 202 is removably disposed in the coupler 270, while FIG. 7B shows the coupler 270 coupled (e.g., crimped) to the conductor 202 via the swage apparatus 780.

As shown in FIG. 7A, the swage apparatus 780 is disposed around the coupler 270 with an axial end the conductor 202 disposed therein in the uncoupled configuration. The swage apparatus 780 may include similar components as the example swage apparatus 680 described with respect to FIG. 6. In some embodiments, the swage apparatus 780 includes o a first die 781a and a second die 781b spaced apart from the first die 781b and disposed around an outer surface of the sleeve 274 of the coupler 270. The swage apparatus 780 may also include a power unit 783, a die block 784, a handle 786, a yoke 782, and a fluid connector 785. The first die 781a, the second die 781b, the power unit 783, the die block 784, the handle 786, the yoke 782, and the fluid connector 785 may be substantially similar in structure and/or function to the first die portion 681a, the second die portion 681b, the power unit 683, the die block 684, the handle 686, the yoke 682, and the fluid connector 685 described with respect to the swage apparatus 680. Therefore, certain features thereof are not described in further detail herein.

The first die 781a and the second die 781b convert the force from the power unit into a circumferential pressure (e.g., 360° radial swage) on the coupler 270. The second die 781b and the first die 781a may define an inner curvature of contour that corresponds to an outer curvature of the coupler 270, for example, to provide a smooth and/or conformal contact with the coupler 270. The conformal contact may provide an even distribution of compressive forces to improve the even flow of material and backward press crimping. In some embodiments, the first and second dies 781a, 781b can be made of hardened steel for durability and resistance to wear and be coated to provide a seamless contact with the coupler 270. In some embodiments, the second die 781b and the first die 781a may be secured through the yoke 782., The yoke 782 may be configured to align the second die 781b and the first die 781a to each other such that the second die 781b and the first die 781a encompass the coupler 270 at about the same distance G6 from the wall 246 of the coupler 270.

In some embodiments, the die block 784 holds the second die 781b. The die block 784 may secure the second die 781b in place during operation while it transfers the load (e.g., a compressive pressure) from the power unit 783 to the second die 781b that is aligned with the first die 781a through the yoke 782. The yoke 782 may provide enough distance for disposing the swage apparatus 780 around the assembly of the conductor 202 and the coupler 270. In some embodiments, the power unit 783 can be hydraulic powered, and may be configured to converts the pressure built up from a pump (not shown) into compressive force that is applied to the die block 784, for example, via a piston included in the power unit 783. In some embodiments, the power unit 783 can be mechanical, electrical, pneumatic, or manually operated (e.g., via the handle 786), as previously described herein. In some embodiments, the fluid connector 785 may be fluidically coupled to a hose or conduit configured to transfer pressurized hydraulic or pneumatic fluid from the pump to the power unit 783. The power unit 783 may be configured to provide sufficient and consistent compressive force during the swaging process at a reasonable speed.

In some embodiments, a first gap G1 exists between an inner surface of the body 272 and an outer surface of the strength member 210 in the uncoupled configuration. In some embodiments, a second gap G2 may exist between an inner surface of the sleeve 274 and outer surface of the conductor layer 220 in the uncoupled configuration. In some embodiments, a third gap G3 may exist between the conductor 202 and the wall 247 or connecting portion 246, in the uncoupled configuration. The third gap G3 may be configured to receive an excess material generated during a crimping of the coupler 270 during backward press crimping, as previously described herein.

In some embodiments, there is a gap G5 between the outer surface of the die 781a and the outer surface of the die 781b of the swage apparatus 780 and the coupler 270 in the uncoupled configuration. In some embodiments, the swage apparatus 780 is disposed at a distance G6 from the wall 247 where it can contact the sleeve 274 of the coupler 270 and apply compressive forces to the coupler 270 that may be transferred to areas, regions, or locations of the coupler 270 where the conductor layer 220 meets the body 272. This may advantageously enable flow of the material into the gap between the G3 gap for backward press crimping. In some embodiments the width of the swage apparatus 780 can be adjusted based on the size of the coupler 270 and/or conductor 202, for example, to provide a bigger surface area for transferring the compressive forces, that may improve backward press crimping.

FIG. 7B shows the coupler 270 and the conductor 202 in a coupled configuration in which the coupler 270 is fixedly coupled into the conductor 202. In some embodiments, the fifth gap G5 between an inner surface the first die 781a (or second die 781b) and an outer surface of the coupler 270 as well as gaps G1 and G2 may be reduced or substantially eliminated during or after coupling. In some embodiments, in the coupled configuration (i.e., after crimping), the fifth gap G5 may be substantially reduced such that the inner surfaces of the first and second dies 781a, 781b contact corresponding outer surfaces of the sleeve 274 of the coupler 270. In some embodiments, the first gap G1 may be substantially removed such that at least a portion of the inner surface of the body 272 may contact at least a portion of the outer surface of the encapsulation layer 214. In some embodiments, the second gap G2 may be substantially removed such that a portion of the inner surface of the sleeve 274 may contact a portion of the outer surface of the conductor layer 220. In some embodiments, the fourth gap, G4 which exists between the conductor 202 and the wall 247 after coupling (FIG. 7B) can be smaller than the gap G3 between the conductor 202 and the wall 247 before coupling (FIG. 7A). This can occur because of the flow of the excess material into the gap G3 between the first conductor 202 and the wall 247 during coupling. The excess material can also flow into the plurality of grooves 276 incorporated into the body 272.

In some embodiments, the swage apparatus 780, for example, the first and second dies 781a, 781b can have a sufficient width to overlap portions of the coupler 270 that include the grooves 275 to facilitate backward press crimping, for example, axial and radial backward press crimping. First, some portion of the strength member 210 and conductor layer 220 can flow into the gap between the conductor 202 and the wall 247 as well as the plurality of grooves 276 defined in the body 272 causing axial backward press crimping. Second, a portion of the conductor layer 220 can flow into the plurality of grooves 275 in the sleeve 274 causing radial backward press crimping. The width and length of the grooves 275 can be adjusted to improve backward press crimping and provide more secure crimping. In some embodiments, the swage apparatus 780 can be configured to exert a compressive force that is higher than a yield strength of the coupler 270 and/or conductor 202, for example, to facilitate plastic deformation. This plastic deformation of material can embed the conductor 202 in the coupler 270 and provide a permanent high strength mechanical bond.

In some embodiments, the swage apparatus 780 may be configured to cause backward press crimping of the coupler 270 to the conductor 202. For example, FIG. 7C is a side view of a portion of the swage apparatus 780 that includes the first die 781a, according to an embodiment. As shown in FIG. 7C, an inner surface 781c of the first die 781a facing the sleeve 274is inclined at an angle a with respect to an outer surface of the sleeve 274 and towards the axial end of the conductor 202, such that a first end of the inner surface of the first die 781a distal from the axial end of the conductor 202 is closer to the sleeve 274 relative to a second end of the inner surface of the first die 781a opposite the first end, which is proximate to the axial end of the conductor 202.

During crimping, the first end contacts the sleeve 274 before the second end, and the inclined inner surface 781c may guide the flow of material of the sleeve 274 and/or body 272 towards the gap between the conductor 202 and the coupler 270, i.e., towards the axial end of the conductor 202 resulting in backward press crimping. In some embodiments, the inclination angle a between the die surface 781c and the coupler 270 may be in a range of about 1 degree to about 5 degrees, inclusive (e.g., about 1 degree, about 2 degrees, about 3 degrees, about 4 degrees, or about 5 degrees, inclusive of all ranges and values therebetween). During swaging process, the compression force will be applied on the wider side of the die 781a (i.e., the first end), and the compression force may propagate towards the narrower side of the die 781a (i.e., the second end) or toward an inner wall of the coupler 270, thus guiding flow of the material toward the gap G3 between the wall 247 and the conductor 202. In some embodiments, the second die 781b may have a similar geometry to the first die 718b, for example, to provide even radial crimping.

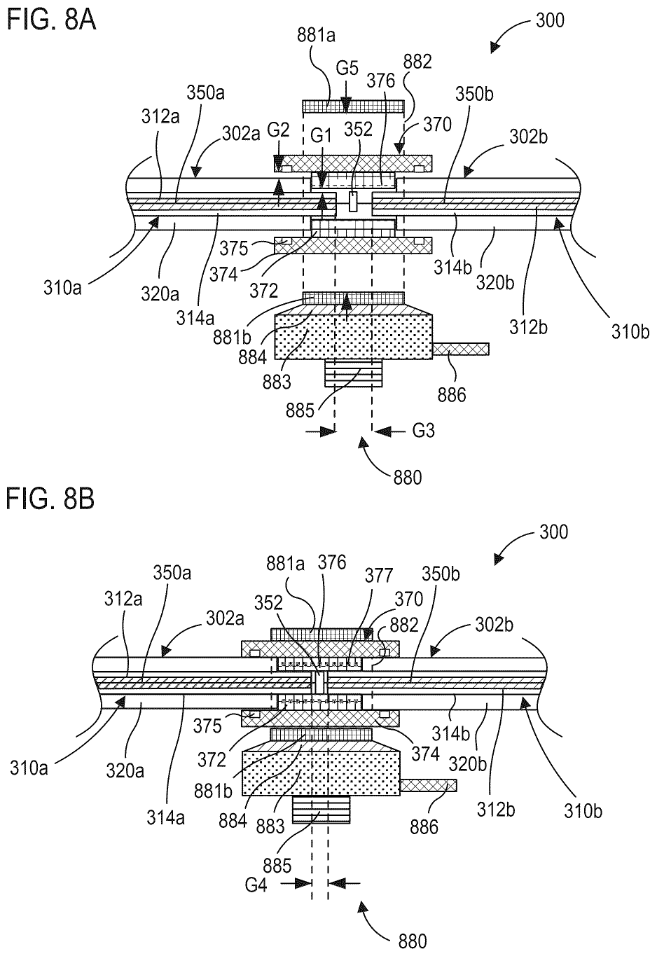

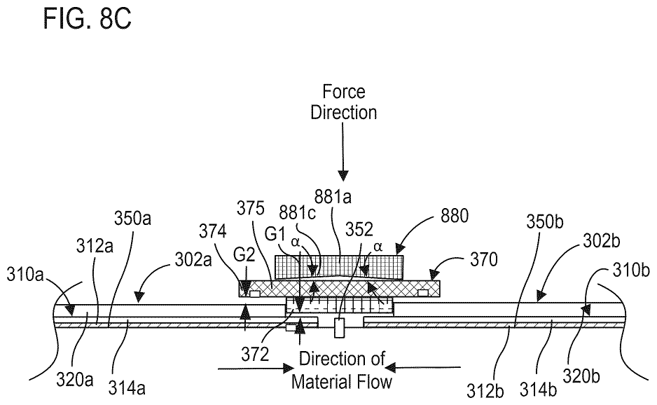

FIG. 8A-8B are side views of the assembly 300 including the coupler 370 that may be configured to splice axial ends of the conductors 302a, 302b using a swage apparatus 880 via backward press crimping, according to an embodiment. The coupler 370 and the conductor 302 were described in detail with respect to FIGS. 3A-3B and therefore, are not described in further detail herein.

FIG. 8A shows the coupler 370, the first conductor 302a and the second conductor 302b in an uncoupled configuration in which the first conductor 302a and the second conductor 302b are removably disposed in the coupler 370. FIG. 8A further includes the swage apparatus 880 which is disposed around the assembly of the coupler 370, the first conductor 302a, and the second conductor 302b in an uncoupled configuration, according to an embodiment. The swage apparatus 880 includes a first die 881a, a second die 881b, a die block 884, a power unit 883, a yoke 882, a handle 886, and a fluid connector 885, which may be substantially similar to the first die 781a, the second die 781b, the die block 784, the power unit 783, the yoke 782, the handle 786, and the fluid connector 785, respectively. Therefore, certain features thereof are not described in further detail herein.

In some embodiments, a width of the swage apparatus 880 may provide enough surface contact between the sleeve 374, and the first and second dies 881a, 881b. In the uncoupled configuration shown in FIG. 8A, the swage apparatus 880 may be disposed around the coupler 370 having axial the first conductor 302a and the second conductor 302b disposed therein, via, for example, the handle 886. The power unit 883 may then be activated, or the handle 886 engaged to cause the first and second dies 881a, 881b to move towards each other and exert compressive force into the area where the body 372 is disposed on the sleeve 374, thus coupling the coupler 370 to the conductors 302a, 302b and splicing them.

In some embodiments, a third gap G3 may exist between the first conductor 302a and the second conductor 302b in the uncoupled configuration. The third gap G3 may be configured to receive an excess material generated during a crimping of the coupler 370. This may, for example, enable safer backward press crimping as the third gap G3 may provide a cavity for the excess material to be disposed in without causing an undesired buildup in pressure within the coupler 370 and/or undesired damage to the conductors 302a, 302b, the coupler 370. In some embodiments, a first gap G1 exists between the inner surface of the body 372 and an outer surface of the first strength member 310a as well as the second strength member 310b. In some embodiments, a second gap G2 may exist between an inner surface of the sleeve 374 and the outer surface of the first conductor layer 320a as well as the second conductor layer 320b. In some embodiments, there is a gap G5 between inner surfaces of the first and second dies 881a, 881b, and corresponding outer surface of the sleeve 374 of the coupler 370 in the uncoupled configuration. In some embodiments, the swage apparatus 880 is positioned such that axial ends of the first and second conductor 302a, 302b are disposed proximate to a middle region of the first and second die 881a, 881b such that the swage apparatus may exert compressive forces on the same surface area of both the first conductor 302a and the second conductor 302b. In some embodiments, the width of the swage apparatus 880 can be increased to provide a bigger contact area to improve backward press crimping.

FIG. 8B shows the coupler 370, the first conductor 302a and the second conductor 302b in a coupled configuration where the first conductor 302a and the second conductor 302b are fixedly coupled to the coupler 370. FIG. 8B further includes the swage apparatus 880 which is disposed around the assembly of the coupler 370 and the first conductor 302a and the second conductor 302b. The handle 886 can be used to dispose the swage apparatus 880 around the coupler 370 with axial ends of the first conductor 302a and the second conductor 302b disposed therein. The power unit 883 converts the pressure built up in the pump through the fluid connector 885 into the compressive force which may transfer to the die block 884, similar to the swage apparatus 780 previously described herein. The die block 884 can transfers the load to the second die 881b and the first die 881a. Therefore, a circumferential or 360 ° radial compressive force is applied to the sleeve 374 via the first and second dies 881a and 881b. The yoke 882 provides a secure contact between the second die 881b and the first die 881a, and hence an even distribution of compressive forces to crimp the coupler 370, the first conductor 302a, and the second conductor 302b.

In some embodiments, the gap G3 is substantially reduced to the gap G4, for example, due to material form the encapsulation layer 314a, 314b flowing under high compressive pressure into the gap G3. The gap G4 between the first conductor 302a and the second conductor 302b is smaller than the gap G3 because of the flow of the excess material into the gap between the conductors 302a, 302b due to axial backward press crimping. In some embodiments, the excess material can also flow into the plurality of grooves 376 defined in the body 372. In some embodiments, a portion of the conductor layers 320a, 320b can flow into the plurality of grooves 375 defined in the body 372 in the coupled configuration, for example, due to radial backward press crimping.

In some embodiments, the swage apparatus 880 may be configured to backward press crimping the coupler 370 to the conductors 302a and 302b to splice them together. For example, FIG. 8C is a side view of a portion of the swage apparatus 880 showing an enlarged view of the first die 881a, according to an embodiment. An inner surface 881c of the first die 881a facing the sleeve 8374 is inclined at an angle a with respect to an outer surface of the sleeve 374 and towards the axial ends of the conductors 302a, 302b, such that opposing ends of the inner surface of the first die 881a distal from the axial ends of the conductor 302a, 302b are closer to the sleeve 374 relative to a central region of the inner surface of the first die 881a, which is proximate to the axial ends of the conductors 302a, 302b. In some embodiments, the first die 881a may have an indentation in the central region or portion resulting in the inclined surface.

During crimping, the opposing ends of the first die 781a (and/or second die 781b) contacts the sleeve 374 before the central region, such that the inclined inner surface 881c may guide the flow of material of the conductor layer 320a, 320b, and/or the encapsulation layer 314a, 341b towards the axial end of the conductors 302a, 302b and into the gap therebetween, resulting in backward press crimping. In some embodiments, the inclination angle a between the die surface 881c and the coupler 370 may be in a range of about 1 degree to about 5 degrees, inclusive (e.g., about 1 degree, about 2 degrees, about 3 degrees, about 4 degrees, or about 5 degrees, inclusive of all ranges and values therebetween). During swaging process, the compression force may be applied on the wider side of the die 881a (i.e., the first end), and the compression force may propagate towards the narrower side of the die 881a (i.e., the second end) or towards an inner wall of the coupler 370, thus guiding flow of the material toward the gap G3 between the wall 347 and the conductors 302a, 302b. In some embodiments, the second die 881b may have a similar geometry to the first die 818b, for example, to provide even radial crimping.

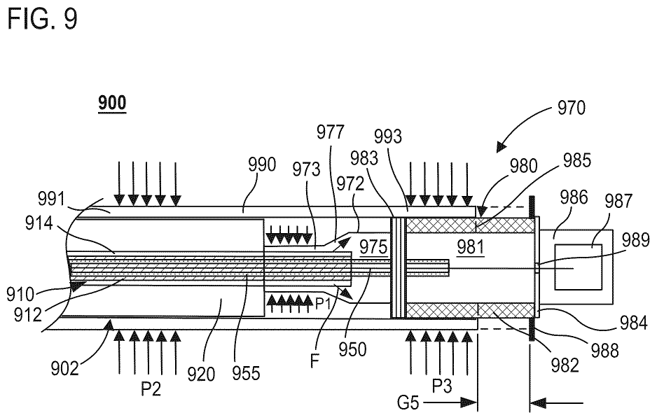

FIG. 9 is a schematic illustration of an assembly 900 including a conductor 902 coupled to a coupler 970, according to an embodiment. The conductor 902 can include a strength member 910, and a conductor layer 920 disposed on the strength member 910. The conductor 902 can further include a strength member 910 including a core 912 having an encapsulation layer 914 disposed therearound. In some embodiments, an optical fiber(s) 950 can be disposed in the core 912. The core 912, the encapsulation layer 914, the optical fiber 950, and the conductor layer 920 may be substantially similar to the core 112, the encapsulation layer 114, the optical fiber assembly 150, and the conductor layer 120, respectively, and, therefore, some aspects thereof are not described in further detail herein.

The coupler 970 can include a first portion 972, a second portion 980 configured to be coupled to the first portion 972, and a third portion 990 configured to be disposed around the first portion 972 and at least a portion of the second portion 980. As shown in FIG. 9, an axial end of the conductor 902 can be disposed at least partially in the first portion 972 of the coupler 970, that is coupled to the second portion 980 of the coupler 970, and the first portion 972 and at least the portion of the second portion 980 is surrounded by the third portion 990 of the coupler 970, according to an embodiment. In some embodiments, an axial end of optical fiber 950 (e.g., a pig tail of the optical fiber 950) can be configured to extend out of the core 912 and communicated through an opening 989 defined in a wall 984 (e.g., end wall) of the third portion 980 of the second portion 980. FIG. 9 shows the assembly of the first portion 972, the second portion 980, and the third portion 990 with the conductor 902 disposed therein, in a coupled configuration using backward press coupling. The coupler 970 can include a dead end coupler configured to be coupled to a pole, a tower, or any other suitable mounting structure, as described herein.

Expanding further, the coupler 970 includes the first portion 972, the second portion 980, and the third portion 990. The first portion 972 can include an overflow chamber 975, and a compression tube 973. The first portion 972 of the coupler 970 is configured to be coupled (e.g., crimped via backward press crimping) to an axial end of the strength member 910. For example, a portion of the conductor layer 920 of the conductor 902 can be removed from an axial end of the conductor 902 to expose a portion of the strength member 910. The core 912 including the exposed portion of the encapsulation layer 914 can be disposed in at least the compression tube 973, for example, extends into and through the compression tube 973 such that a portion of the axial end of the exposed strength member 910 is disposed in the overflow chamber 975 of the first portion 972 of the coupler 970. The exposed portion of the strength member 910 can be crimped to the compression tube 973 via backward press crimping, for example, via application of a first force indicated by the arrows P1 in FIG. 9. The first force P1 can be evenly distributed in radial direction and cause the compression tube 973 to be crimped to the encapsulation layer 914.

The backward press crimping forces applied on the compression tube 973 of the first portion 972 can cause the encapsulation layer 914 (e.g., including a metal such as aluminum) to flow towards the overflow chamber 975. The overflow chamber 975 can be configured to accommodate the excess material of the encapsulation layer 914 material flowing into the overflow chamber 975. In some embodiments, a wall 977 of the first portion 972, for example, a wall connecting the compression tube 973 to the overflow chamber 975 may be inclined at an angle away from compression tube 973 such that there is a gradual increase in a cross-sectional area from the compression tube 973 to the overflow chamber 975. The inclined wall 977 may be configured to direct the excess material of the encapsulation layer 914 towards the sidewalls of the overflow chamber 975 as indicated by the arrows F, and away from the core 912, for example, to inhibit the overflow of the encapsulation layer 914 from contacting the optical fiber 950 that can damage the optical fiber 950.

In some embodiments, the optical fiber(s) 950 may be disposed within a protection sleeve 955 within the encapsulation layer 914, which is configured to protect the optical fiber 950 from damage during backward press crimping. In some embodiments, a protection sleeve 955 or jacket (not shown) may also be disposed between the core 912 and the encapsulation layer 914, and configured to at least one of direct flow of the encapsulation layer 914 material away from the core 912, and/or protect the optical fiber 950.

In some embodiments, the protection sleeve 955 can define an internal cross-section that is substantially larger than the optical fiber 950 disposed therein, such that the optical fiber sits loosely within the protection sleeve 955. In some embodiments, an internal cross-section of the protection sleeve 955 can be configured to reduce excess space to inhibit movement or micro bending of the optical fiber 950. In some embodiments, the protection sleeve 955 can include a heat-shrink sleeve or protective tube. In some embodiments, the inner diameter of the protection sleeve 955 can be slightly larger than the outer diameter of the optical fiber 950. In some embodiments, the outer diameter of the protection sleeve 955 can be slightly smaller than the outer diameter of the core 912. In some embodiments, the protection sleeve 955 can protect the optical fibers 950 against bending, tension, and environmental stress. In some embodiments, the protection sleeve 955 can be transparent to allow visual inspection of the optical fiber disposed therein.

In some embodiments, the protection sleeve 955 can extend into the first portion 972, for example, up to the overflow chamber 975. In some embodiments, the protection sleeve 955 can extend into the inner volume 981 defined by the second portion 980, as shown in FIG. 9. The optical fiber 950 may extend out of the protection sleeve 955 to, for example, be routed out of the second portion 980, as previously described.

In some embodiments, the first portion 972 of the coupler 970 may be configured to be coupled to the second portion 980 of the coupler 970, for example, via thread, snap-fit, friction fit, adhesives, bonding (e.g., fusion bonding), welding, etc. For example, as shown in FIG. 9, threads (not shown) may be provided on an external surface of the overflow chamber 975 at an axial end thereof that is distal from the conductor 902. Mating threads 983 may be defined on an inner surface of the second portion 980 proximate to the first portion 972 and configured to engage the threads on the first portion 972 to couple the first portion 972 to the second portion 980.

In some embodiments, the second portion 980 of the coupler 970 can be a dead-end coupler. The second portion 980 of the coupler 970 can include a sleeve 982 that is configured to be coupled to the first portion 972 and defines the mating threads 983. In some embodiments, the sleeve 982 can be formed from a conductive material, for example, aluminum, alloys, copper, stainless steel, any other suitable material, or any suitable combination thereof. The sleeve 982 can have a diameter greater than the diameter of the overflow chamber 975 so as to allow an axial end of the overflow chamber 975 to be inserted into the sleeve 982. In some embodiments, the sleeve 982 can define an inner volume 981 configured to receive axial end of the optical fiber 950 extending out of the core 912 and optionally, at least a portion of the strength member 910.

The second portion 980 of the coupler 970 can further include a wall 984 (e.g., an end wall) fixedly coupled (e.g., bonded, welded, etc.) or removably coupled (e.g., via threads, snap-fit, etc.) to an axial end of the sleeve 982 that is distal from the conductor 902. In some embodiments, an opening 989 can be defined on the wall 984 of the connecting portion 986 adjacent to the sleeve 982. The optical fiber 950 or any other portion of the conductor 902 can be routed out of the coupler 970 through the opening 989 for coupling with a controller or receiver. The diameter of the opening 989 can be equal or greater than the diameter of the optical fiber 950. In some embodiments, a sealing gasket can be used to ensure proper sealing of the optical fiber through the opening 989. In some embodiments, a plurality of optical fibers 950 can extend out of the opening 989. In some embodiments, the strength member 910 can extend out of the opening 989.

The second portion 980 can also include connecting portion 986 coupled to the wall 984 (e.g., welded or bonded thereto or monolithically formed therewith). In some embodiments, the connecting portion 986 may define a keyhole 987 configured to allow the second portion 980 and thereby, the first portion 972 and the conductor 902 to a pole, a tower, or any other suitable mounting structure, as described herein. For example, the keyhole 987 may be configured to couple to corresponding hooks or connectors located on poles (e.g., tension towers) from which the conductor 902 may be suspended.

In some embodiments, a protective cap 988 can be disposed at the second axial end, at an interface of the sleeve 982 and the connecting portion 986. The protective cap 988 can include a strong and rigid material (e.g., metals, alloys, plastics, polymers, etc.) extending radially from the sleeve 982 and may be configured to absorb a crimping force or direct the force away from the connecting portion 986, for example, when a third portion 990 of the coupler 970 is crimped onto the conductor 902 and the second portion 980, as described herein.

In some embodiments, the first portion 972 and the second portion 980 can be separate pieces that are coupled to each other, as described herein. In some embodiments, the first portion 972 and the second portion 980 can include a single unibody component, for example, the first portion 972 and the second portion 980 can be monolithically formed. In other words, the first portion 972 and the second portion 980 can be integrally formed as a single body. In some embodiments, the unibody can be manufactured in a single manufacturing step via molding, machining, or additive manufacturing such that the first portion 972 and the second portion 980 are not separate components. In some embodiments, the first portion 972 and the second portion 980 can be formed from a single piece of material. In some embodiments, integration of the first portion 972 and the second portion 980 can improve durability, reduce cost, improve alignment, and reduce the coupling time.

In some embodiments, the first portion 972 can be coupled to the strength member 910 or the third portion 990 can be coupled to the conductor layer 920 and/or to the second portion 980 through a crimping apparatus (not shown). In some embodiments, the crimping apparatus can be a hexagonal crimp die or any other suitable crimping apparatus. In some embodiments, the crimping apparatus can include a swage apparatus (e.g., the swage apparatus 680 or any other swage apparatus described herein). The hexagonal crimp die can include a crimping cavity configured to receive at least a portion of the conductor 902 and the coupler 970. The hexagonal crimp die has a hexagonal cross-sectional profile. The hexagonal geometry can include rounded or chamfered corners to reduce stress risers and facilitate insertion. In some embodiments, the die can be part of a manual, hydraulic, or pneumatic crimping tool such as a swage apparatus. In some embodiments, the hexagonal crimp die can include guide pins for alignment. In some embodiments, the hexagonal crimp die can be interchangeable to accommodate different conductor sizers or coupler geometries. The crimping apparatus can be configured to mechanically secure the conductor 902 to a coupler 970.

In some embodiments, the coupler 970 further includes a third portion 990. The third portion 990 can be include an outer sleeve configured to be disposed around an axial end of the conductor 902, the first portion 972, and at least a portion of the sleeve 982 of the second portion 980. In some embodiments, the third portion 990 may be formed from a conductive material such as metals (e.g., aluminum). The third portion 990 can include an elongated hollow cylinder that can be inserted over the first portion until a first axial end 991 of the third portion is disposed over the conductor layer 920 of the conductor 902, and a second axial end 993 of the third portion 990 is disposed over the sleeve 982 such that the third portion 990 covers at least a portion of the conductor layer 920, the first portion 972, and the second portion 980. In some embodiments, the second portion 980 can be coupled to the first portion 972 after disposing the third portion 990 over the conductor layer 920.

In some embodiments, the third portion 990 may define an internal diameter that corresponds to an outer diameter of the conductor layer 920 (e.g., have a diameter that is substantially equal to or slightly larger than the outer diameter of the conductor layer 920). The third portion 990 is conductor is configured to electrically couple the conductor layer 920 to the sleeve 982 and thus, the second portion 980. For example, the first axial end 991 of the third portion 990 may be backward press crimped to the conductor layer 920 by applying a force indicated by the arrows P2 on the first axial end 991 to fixedly coupled the third portion 990 to the conductor layer 920.

As shown in FIG. 9, the second axial end 993 of the third portion 990 of the coupler 970 can be disposed over a portion of the sleeve 982 and backward press crimped onto by applying a force on the second axial end 993 in a direction indicated by the arrows P3. Backward press crimping of the second axial end 993 may cause the material (e.g., aluminum) of the third portion to flow towards the wall 984. If the third portion 990 is flush with the wall 984 before backward press crimping, the flowing material of the third portion 990 at the second axial end 993 may damage or even break the wall 984 or the connecting portion 986. To protect the second portion 980, the second axial end 993 of the third portion 990 is disposed on only a portion of the sleeve 982 such that a gap G5 is present between the second axial end 993 of the third portion 990 and the wall 944. In some embodiments, an alignment mark 985 (e.g., a notch or marking) may be provided on an outer surface of the sleeve 982 that is configured to be aligned with the second axial end 993 of the third portion 990 such that the gap G5 remains. The gap G5 may be in a range of 1 mm to 10 mm, inclusive, and configured to accommodate material flow at the second axial end 993 of the third portion over the sleeve 982 during backward press crimping. As previously described, the protective cap 988 may be configured to provide a cushioning for the excess material flow and thus, protect the wall 984 of the second portion 980 from the damage. In this manner, the third portion 990 may be backward press coupled (e.g., crimped) to the conductor layer 920 and the second portion 980 to electrically coupled the conductor layer to the second portion 980.

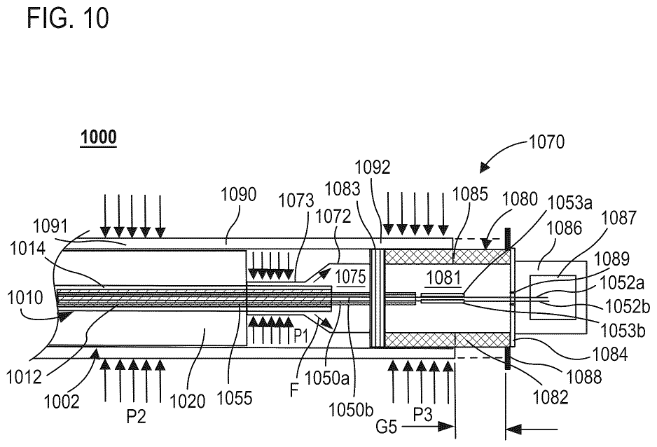

FIG. 10 is a schematic illustration of an assembly 1000 including a conductor 1002 having an axial end thereof coupled to a coupler 1070, according to an embodiment. The conductor 1002 can include a strength member 1010, and a conductor layer 1020 disposed on the strength member 1010. The strength member 1010 can include a core 1012 having an encapsulation layer 1014 disposed therearound. In some embodiments, optical fibers 1050a and 1050b (collectively referred to herein as “optical fibers 1050”) disposed in the core 1012. The core 1012, the encapsulation layer 1014, the optical fiber 1050, the protection sleeve 1055 and the conductor layer 1020 may be substantially similar to the core 912, the encapsulation layer 914, the optical fiber 950, the protection sleeve 955 and the conductor layer 920, respectively, and, therefore, some aspects thereof are not described in further detail herein. While show as including two optical fibers 1050, n some embodiments, the conductor 1002 can include a single optical fiber, or more than two optical fibers 1050a disposed in or adjacent to the core 1012.

In some embodiments, the coupler 1070 can include a first portion 1072, a second portion 1080, and a third portion 1090. The first portion 1072 can include a compression tube 1073 and an overflow chamber 1075 that may be substantially similar to the compression tube 973 and the overflow chamber 975 of the first portion 972 and therefore, some aspects thereof are not described in further detail herein. In some embodiments, the second portion 1080 of the coupler 1070 can further include a sleeve 1082 defining an inner volume 1081, external threads 1083 configured to couple the sleeve 1082 to the overflow chamber 1075, a wall 1084 defining an opening 1089, a connecting portion 1086 defining a keyhole 1087, and a protective cap 1088. The sleeve 1082, the wall 1084, the connecting portion 1086, and the protective cap 1088 can be substantially similar to the sleeve 982, the wall 984, the connecting portion 986 and the protective cap 988, respectively and therefore some aspects thereof are not described in further detail herein.

In some embodiments, a portion of the conductor layer 1020 can be removed from the end of the conductor 1002 to expose a portion of the strength member 1010. The core including the exposed portion of the encapsulation layer 1014 can be removably disposed in the compression tube 1073 of the first portion 1072. The exposed portion of the encapsulation layer 1014 can be crimped to the compression tube 1073 via a crimping apparatus. The arrows indicated by P1 show backward press crimping forces applied via a crimping apparatus on the compression tube 1073 to the strength member 1010, as previously described herein.

While the second portion 1080 of the coupler 1070 is substantially similar to the second portion 980 of the coupler 970, different from the assembly 900, axial ends of optical fibers 1050 of the conductor 1002 extend only into the inner volume 1081 defined by the sleeve 1082 are not extended out of the opening 1089. Instead, axial ends of another set of optical fibers 1052a and 1052b (collectively referred to herein as “optical fibers 1052”) that are external to the coupler 1070 are inserted through the opening 1089 into the inner volume 1081 and coupled to the axial ends of the corresponding optical fibers 1050, for example, via optical couplers 1053a, 1053b (collectively referred to as 1053), for example, fusion splice couplers. In some embodiments, a sealing member (not shown) may be disposed in the opening 1089 and configured to protect the external optical fibers 1052 from damage during insertion through the opening 1089, and/or substantially hermetically seal the inner volume 1081.

In some embodiments, coupling of the optical fibers 1050 to the external optical fibers 1052 may include removing a cladding of optical fibers 1050 and 1052. The optical fibers 1050 of the conductor 1002 and external optical fibers 1052 can be cleaned to remove dust and oils. Each fiber can be precisely cut to create a flat, perpendicular end face. The axial end of two optical fiber 1050 of the conductor 1002 and external optical fiber 1052 can be placed into the corresponding optical coupler 1053 and coupled (e.g., fusion coupled) thereto. This can be especially useful in aerial installation and/or fiber to the home deployments, and can further facilitate maintenance and identification.

In some embodiments, the optical coupler(s) 1053 can include a fusion splicer. In some embodiments, the splicer 1053 can permanently join two optical fibers by melting their ends together using an electric arc. The electric arc can melt the glass ends of the optical fibers and fuse them together into a single continuous fiber. In some embodiments, the core alignment can reduce the splice loss. In some embodiments, fusion splicer can use a camera and motor to align the cores with sub-micron precision. In some embodiments, the optical coupler 1053 can be disposed within the second portion 1080 of the coupler 1070. In some embodiments, the conductor 1002 can include a plurality of optical fibers 1050. In some embodiments, a second plurality of optical fibers 1052 can enter to the second portion 1080 of the coupler 1070 via the opening 1089 from an external source. In some embodiments, a plurality of optical couplers 1053 can be disposed within the inner volume 1081 of the second portion 1080 of the coupler 1070 to join the plurality of optical fibers 1050 of the conductor 1002 to the second plurality of optical fibers 1052 from the external source. The spliced area can be protected with a splice sleeve (e.g. a heat-shrink tube with a reinforcing rod). In some embodiments, an access window (not shown) can be disposed in the sleeve 1082 to allow access to the inner volume 981 of the sleeve 982 to facilitate coupling of the optical fibers 1050 to the external optical fibers 1052.

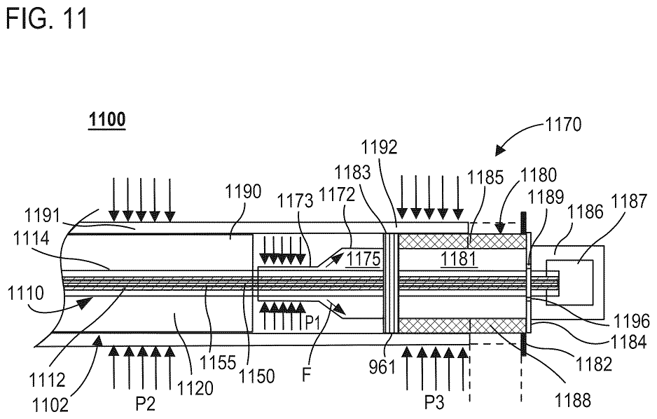

FIG. 11 is a schematic illustration of an assembly 1100 conductor 1102 coupled to a coupler 1170, according to an embodiment. The conductor 1102 can include a strength member 1110, and a conductor layer 1120 disposed on the strength member 1110. The strength member 1110 can include a core 1112 having an encapsulation layer 1114 disposed therearound. In some embodiments, an optical fiber 1150 can be disposed in the core 1112. The core 1112, the encapsulation layer 1114, the optical fiber assembly 1150, the protection sleeve 1155 and the conductor layer 1120 may be substantially similar to the core 912, the encapsulation layer 914, the optical fiber 950, the protection sleeve 955, and the conductor layer 920, respectively, and therefore, some aspects thereof are not described in further detail herein.

In some embodiments, the coupler 1170 can include a first portion 1172 configured to be coupled to a second portion 1180, and a third portion 1190 configured to be coupled to the conductor layer 1120 at least a portion of the third portion 1190, as shown in FIG. 11. In some embodiments, the first portion 1172 can include a compression tube 1173, and overflow chamber 1175. The compression tube 1173 and overflow the overflow chamber 1175 may be substantially similar to the compression tube 973 and overflow chamber 975, respectively and therefore, some aspects thereof are not described in further detail herein. The second portion 1180 of the coupler 1170 can further include a sleeve 1182 defining an inner volume 1181 and threads 1183 on a first axial end thereof proximate to the first portion 1172, a wall 1184 coupled to a second axial end of the sleeve 1182 opposite the first end, a connecting portion 1186 defining a keyhole 1187, and a protective cap 1188. The sleeve 1182, the wall 1184, the connecting portion 1186, and the protective cap 1188 can be substantially similar to the sleeve 982, the wall 984, the connecting portion 986, and the protective cap 988 as described in FIG. 9. Therefore, some aspects thereof are not described in further detail herein.

The third portion 1190 may define a tubular portion that has a first axial end configured to be disposed over and coupled to an axial end of the conductor layer 1120 (e.g., via backward press crimping), and a second axial end configured to be coupled at least a portion of the sleeve 1182 of the second portion 1180. The third portion 1190 may be substantially similar to the third portion 990 described with respect to the assembly 900 of FIG. 9, and therefore not described in further detail herein.

Different from the assembly 900 and 1000, the wall 1184 of the second portion 1180 of the coupler 1170 defines an opening 1189 therethrough that is sized and shaped to receive a portion of the strength member 1110 of the conductor 1102 therethrough. For example, the strength member 1110 can extend into the inner volume 1181 defined by the second portion 1180, and through opening 1189 to a region external to the second portion 1180 of the coupler 1170. In some embodiments, a sealing member 1196 may be disposed in the opening 1189 and configured to form a seal around the portion of the strength member 1110 that extends through the opening 1189, for example, to maintain the inner volume 1181 substantially hermetically sealed.

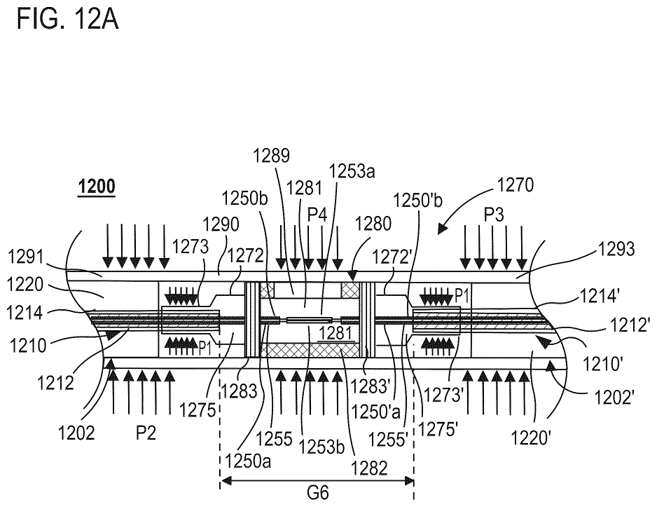

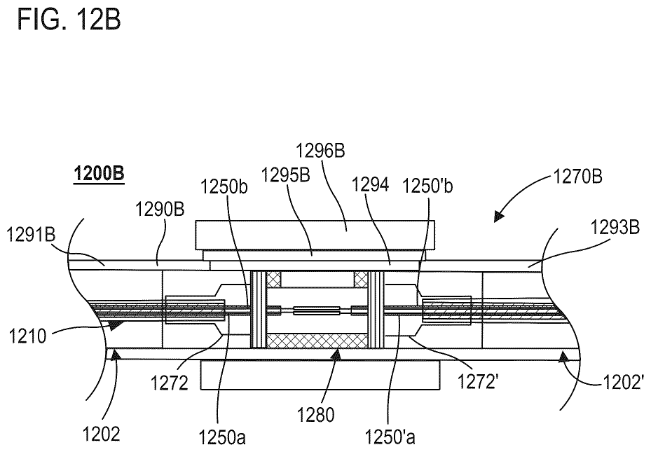

FIG. 12A is a schematic illustration of an assembly 1200 a first conductor 1202 and a second conductor 1202′ having axial ends thereof coupled thereto via a coupler 1270 (e.g., a splice coupler), according to an embodiment. The conductors 1202, 1202′ include a strength member 1210, 1210′ that includes a core 1212, 1212′ and an encapsulation layer 1214, 1214′ disposed over the core 1212, 1214′, and a conductor layer 1220, 1220′ disposed over the conductor layer 1220, 1220′. The conductors 1202, 1202′ may be substantially similar to the conductor 102, 902, 1002, 1102, described herein and therefore, not described in further detail herein.

The coupler 1270 includes a first conductor first portion 1272 configured to be coupled to the strength member 1210 of the first conductor 1202, and a second conductor first portion 1272′ (collectively referred to herein as “first portions 1272”) configured to be coupled to the strength member 1210′ of the second conductor 1202′. The first conductor 1202, and the second conductor 1202′ can be substantially similar to the conductor 902 previously described in FIG. 9, thus certain aspects of the first conductor 1202 and the second conductor 1202′ are not described in further detail herein. The first portions 1272, 1272′ include a compression tube 1273, 1273′ configured to be coupled to the strength member 1210, 1210′ via backward press crimping by application of a force in a direction indicated by the arrows P1, and an overflow chamber 1275, 1275′ extending from the compression tube 1273, 1273′ and configured to accommodate overflow of the encapsulation layer 1214, 1214′ during backward press crimping. The first portion 1272, 1272′ may be substantially similar to the first portions 972, 1072, 1172, and therefore, not described in further detail herein. As shown in FIG. 12A, when coupled to the respective strength members 1210, 1210′, the first portions 1272, 1272′ may resemble mirror images of each other.

In some embodiments, the coupler 1270 can include a second portion 1280 configured to be coupled to each of the first portions 1272 and defines an inner volume 1281 within which portions of the first portions 1272 may protrude. For example, the second portion 1280 may define a first set of threads 1283 (or any other coupling mechanism described herein) on a first axial end thereof proximate the first conductor first coupler 1272 and configured to be coupled to mating threads defined on the overflow chamber 1275, and a second set of threads 1283′ defined on a second axial end of thereof opposite the first axial end that is configured to be coupled to be coupled to mating threads defined on the overflow chamber 1275′ of the second conductor first portion 1272′. In this manner, the second portion 1280 may be configured to couple the first portions 1272 to each other, thus coupling or splicing the first conductor 1202 to the second conductor 1202′.

In some embodiments, the second portion 1280 may include an access window 1289 defined in a wall thereof, for example, to facilitate alignment and coupling of optical fibers from the first conductor 1202 to the second conductor 1202′. For example, as shown in FIG. 12A, the first conductor 1202 can include a first pair of optical fibers 1250a and 1250b (collectively referred to herein as “optical fibers 1250”) disposed through the core 1212 thereof, and the second conductor 1202 can include a second pair of optical fibers 1250′a and 1250′b (collectively referred to herein as “optical fibers 1250′”) extending through the core 1212′ thereof. Axial ends of the optical fibers 1250 and 1250′ may protrude from the axial ends of corresponding strength members 1210, 1210′ into the inner volume 1281 and coupled within the inner volume 1281 via optical couplers 1253a, 1253b (e.g., fusion splice couplers). In some embodiments, the optical fibers 1250 and 1250′ can be coupled to a protection sleeve 1255 and 1255′. The access window 1289 may allow a user to couple the first portions 1272 to the second portion 1280 first, and then access the inner volume 1281 to couple the first pair of optical fibers 1250 to the second set of optical fibers 1250′.

In some embodiments, a Gap G6 can exist between the end of the first conductor 1202 and the second conductor 1202′, for example, due to the first portions 1272 and the second portions 1280 of the coupler 1270 disposed therebetween. The gap G6 provides a space for splicing optical fibers 1250, 1250′. In some embodiments, the second portion 1280 can be extended to allow fusion splice of optical fibers 1250, 1250′. In some embodiments, the length of the second portion 1280 can be at least about 30 cm, at least about 40 cm, at least about 50 cm, at least about 60 cm, at least about 70 cm, at least about 80 cm, at least about 90 cm, at least about 100 cm. In some embodiments, the length of the common second portion 1280 can no more than about 100 cm, no more than about 90 cm, no more than about 80 cm, no more than about 70 cm, no more than about 60 cm, no more than about 50 cm, no more than about 40 cm, no more than about 30 cm. Combinations of the above-referenced lengths are also possible (e.g., at least about 30 cm and no more than about 100 cm or at least about 50 cm and no more than about 80 cm), inclusive of all values and ranges therebetween. In some embodiments, the length of the common second portion 1280 can be about 30 cm, about 40 cm, about 50 cm, about 60 cm, about 70 cm, about 80 cm, about 90 cm, about 100 cm.

The third portion 1290 of the coupler 1270 can be configured to be coupled to axial ends of the conductor layer 1220 of the first conductor 1202 to the conductor layer 1220′ of the second conductor 1202 to electrically couple the first conductor 1202 to the second conductor 1202″. For example, a first axial end 1291 of the third portion 1290 may be backward press crimped to the axial end of conductor layer 1220 of the first conductor 1202 by application of a force indicated by the arrows P2 in FIG. 12A. Similarly, a second axial end 1293 of the third portion 1290 may be backward press crimped to the axial end the conductor layer 1220′ of the second conductor 1202′ by application of a force indicated by the arrows P3 in FIG. 12A, such that the first portions 1272 and the second portion 1280 are disposed within an internal volume defined by the third portion 1290. In some embodiments, the third portion 1290 may also be crimped (e.g., forward or backward press crimped) to the second portion 1280.

In some embodiments, a portion of the first conductor layer 1220 and the second conductor layer 1220′ can be removed from an axial end of the first conductor 1202 and the second conductor 1202′ to expose a portion of the encapsulation layer 1214. The first strength member 1210 can be disposed in the first compression tube 1273 and the second strength member 1210′ can be disposed in the second compression tube 1273′. The exposed portion of the encapsulation layer 1214 of the first conductor 1202 and the exposed portion of the encapsulation layer 1214′ of the second conductor 1202′ can be crimped to the first compression tube 1273 and the second compression tube 173′ via a crimping apparatus. The arrows indicated by P1 show the forces applied via a crimping apparatus on the first compression tube 1273 and the second compression tube 1273′. The forces P1 can be evenly distributed in radial direction. P1 can crimp the compression tube 1073 to the encapsulation layer 1014. The excess material can flow to the first overflow chamber 1275 and the second overflow chamber 1275′.

The second portion 1280 can then be coupled to the first portions 1272 to couple the strength members 1210 and 1210′ to each other. The third portion 1290 may be pre disposed on one of the first conductor 1202 or the second conductor 1202′ before initiating the coupling between the two conductors 1202, 1202′. Once the second portion 1280 is coupled to each of the first portions 1272, the third portion 1290 may be positioned over the respective conductor layers 1220, 1220′ as described herein, and coupled thereto via backward press crimping, and may optionally, be also crimped to the second portion 1280.

FIG. 12B is a schematic illustration of an assembly 1200B including the first conductor 1202 and the second conductor 1202′ having axial ends thereof coupled thereto via a coupler 1270B, according to an embodiment. The coupler 1270B includes the first portions 1272, 1272′, and the second portion 1280, as previously described with respect to the assembly 1200. However, different from the third portion 1290 of the coupler 1270 of FIG. 12A, the coupler 1270B includes a third portion 1290B that defines a window 1294B in a wall thereof. The window 1294B can define an opening that provides access to or visibility into the interior of the coupler 1270B, for example, to allow manipulation of the internal components disposed within the third portion 1290B of the coupler.

In some embodiments, a cover 1295B can be removably disposed over the window 1294B, for example, removable to allow access to inner volume of the third portion 1290B, and redisposed on the window 1294B to seal (e.g., substantially hermetically seal) the inner volume of the third portion 1290B. In some embodiments, the cover 1295B can be secured with a snap-fit engagement where the cover 1295B includes one or more flexible tabs or protrusions that engage with corresponding recesses or dents in the third portion 1290B, for example, within the window 1294B to allow removable coupling of the cover 1295B to the third portion 1290B. In some embodiments, the cover 1295B may be configured to be disposed over the window 1294B, for example, to rest on an outer surface of the third portion 1290B over the window 1294B. In some embodiments, the cover 1295B can be configured to be disposed substantially within the window 1294B. For example, a ledge (not shown) can be defined along a lower boundary of the window 1294B on which the cover 1295B rests when disposed within the window 1294B.

In some embodiments, the cover 1295B can be secured using a hinged connection, allowing the cover 1295B to pivot between open and closed positions. In some embodiments, a friction fit, magnetic attachment or adhesive bonding can secure the cover 1295B. In some embodiments, the cover 1295B can be formed from a transparent, translucent, or opaque material depending on the intended function. In some embodiments, a sealing member (not shown) can be disposed on a surface of the cover 1295B or alternately, within the window 1294B, and configured to form a seal around, or proximate a perimeter of the cover 12995B. In some embodiments, the seal member can provide environmental protection, such as moisture or dust resistance.

In some embodiments, a clamp 1296B can be disposed on or around the third portion 1290B of the coupler 1270B, for example, to secure to cover 1295B on the window 1294B. In some embodiments, the clamp 1296B can also be configured to secure the third portion 1290B of the coupler 1270B on the first portion 1272B and the second portion 1280 coupled to the conductors 1202 and 1202′. The clamp 1296B can be configured to apply a radial compressive force to maintain mechanical contact between the third portion 1290B of the coupler 1270B and the second portion 1280B of the coupler 1270B. The clamp 1296B can be a separate component, or integral with the third portion 1290B of the coupler 1270B. In some embodiments, the clamp 1296B can be a single piece or two-piece clamp. In some embodiments, the clamp 1296B can be made from a metallic or polymeric material and may include textured inner surface to enhance grip.

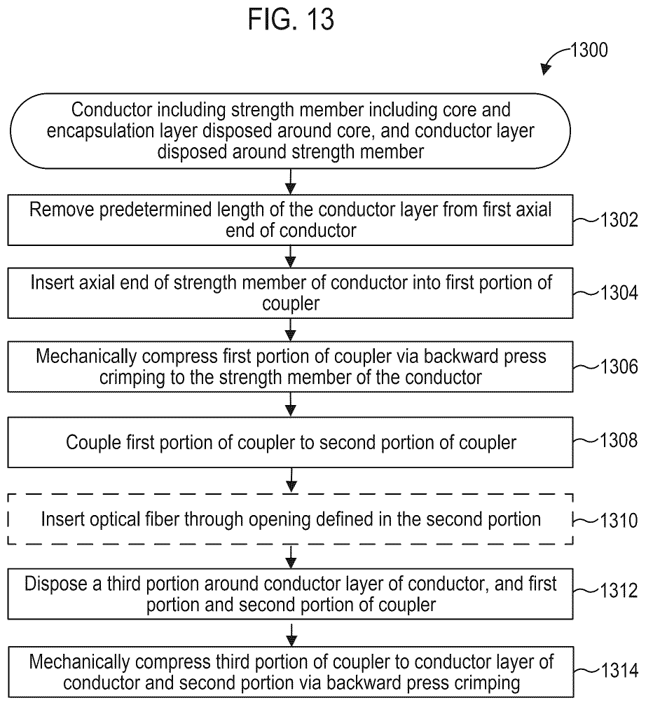

FIG. 13 is a schematic flow chart of a method 1300 for coupling a conductor (e.g. the conductor 902) to various portions of a coupler (e.g., the coupler 970), according to an embodiment. While described with respect to the conductor 902 and the coupler 970, the operations of the method 1300 can be used to couple any conductor to any coupler using backward press crimping. All such implementations are envisioned and should be considered to be within the scope of the present disclosure.

The method 1300 includes removing a portion or length of the conductor layer 920 an end of the conductor 902 to expose a portion of the strength member 910 of the conductor 902 (e.g., a portion having a length in a range of about 150 mm to about 350 mm, inclusive, from the end of the conductor 902), at 1302, as previously described herein. For example, a circumcizer, a cutter or any other suitable equipment may be used to make slits or cuts in the conductor layer 920 of the conductor 902 proximate to an end of the conductor 902 and the portion of the conductor layer 920 of the conductor 902 to expose a portion of the strength member 910 thereof.

At 1304, the strength member of the conductor 902 is inserted into a compression tube 973 of the first portion 972 of the coupler 970, as previously described herein. In some embodiments, the compression tube 973 of the first portion 972 of the coupler 970 have inner cross-sectional widths (e.g., diameters) that are larger than corresponding outer cross-sectional widths of the strength member 910. This allows a gap to be present between inner surfaces of the compression tube 973 and conductor 902. In some embodiments, the cross-sectional widths of the overflow chamber (e.g. diameters) are large than corresponding outer cross-sectional widths of the compression tube 973 of the first portion 972 of the coupler 970.

At 1306, the compression tube 973 of the first portion 972 of the coupler 970 is mechanically compressed (e.g., via backward press crimping) on to the strength member 910 to cause the first portion 972 to be coupled to the conductor 902 such that the gap between an inner surface of the compression tube 973 and the outer surface of the strength member 910 is substantially eliminated. The overflow chamber 975 may be configured to receive material overflow of the encapsulation layer 914 and direct the overflow material away from the core 912, as previously described herein.

At 1308, the first portion 972 of the coupler 970 can be coupled to the second portion 980 of the coupler 970, as previously described herein. In some embodiments, the connecting portion 986 of the coupler 970 may be configured to be coupled to a pole (e.g., an electrical pole or tower). For example, a hook, rope, coil, or any other coupling mechanism may be interfaced with the keyhole 987 defined in the connecting portion 986 to couple the coupler 970 to the pole.

In some embodiments, an optical fiber 950 from within the core 912 is extended out of the core 912 and inserted through the opening 989 defined in the wall 984 of the second portion of the coupler 970 or any other opening defined in the second portion 980, as previously described herein. In some embodiments, external optical fibers (e.g., optical fibers 1052) may be routed through an opening (e.g., the opening 1089 into an inner volume (e.g., inner volume 1081) defined by the second portion (e.g., second portion 1080) and coupled to axial ends of optical fiber(s) (e.g., optical fibers 1050) extending out of the core (e.g., core 1012) within the inner volume (e.g., via optical couplers 1053), as described herein with respect to the coupler 1070. In some embodiments, the strength member (e.g., strength member 1110) may be extended through the first portion (e.g., first portion 1172) and the second portion (e.g., through the inner volume of the second portion 1180), and through an opening defined in the wall of the second portion (e.g., the opening 1189) out through a back end of the coupler, as previously described herein with respect to the coupler 1170.

At 1312, the third portion 990 of the coupler 970 is disposed around an axial end of the conductor layer 920, the first portion 972, and at least a portion of the second portion 980 (e.g., the sleeve 982) of the coupler 970. At 1314, the third portion 990 can be mechanically compressed (e.g., backward press crimped) to cause the third portion 990 of the coupler 970 to be coupled to the conductor 902 and the second portion 980. For example, the first axial end 991 of the third portion 990 is coupled to the conductor layer 920 of the conductor 902, and the second axial end 993 of the third portion 990 is coupled to the sleeve 982 of the second portion 980 via backward press crimping, as previously described herein.

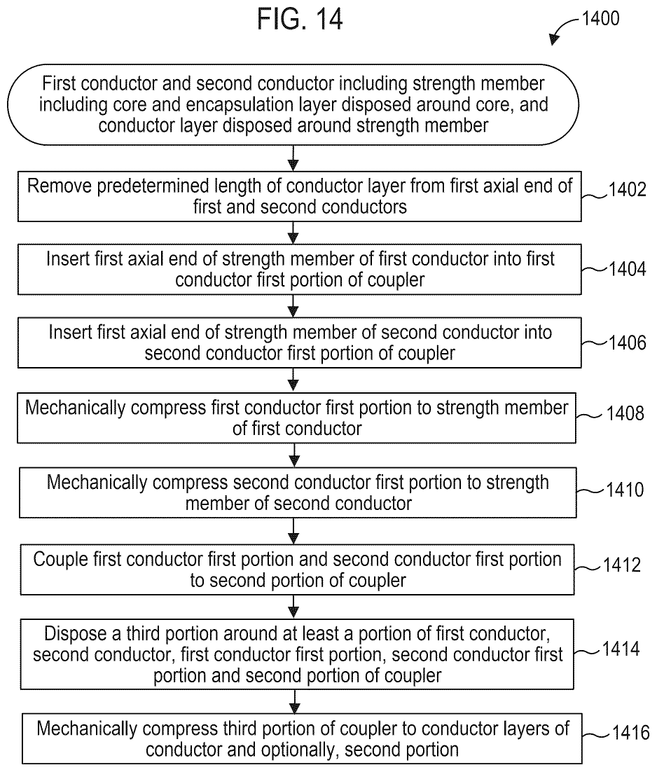

FIG. 14 is a schematic flow chart of a method 1400 for coupling a first conductor 1202 and a second conductor 1202′ (e.g., splice first conductor 1202 to second conductor 1202′) via a coupler 1270, according to an embodiment. While described with respect to the conductors 1202, 1202′, and the coupler 1270 the operations of the method 1400 can be used to splice any conductor to any coupler using crimping. All such implementations are envisioned and should be considered to be within the scope of the present disclosure.

The method 1400 includes removing a portion or length of the conductor layers 1220, 1220′ from first ends of each of the first conductor 1202 and the second conductor 1202′ to expose a portion of the respective strength members 1210, 1210′ of the first and second conductors 1202, 1202′ (e.g., removing a portion having a length in a range of about 150 mm to about 350 mm, inclusive, from the axial end of the conductors 1202, 1202′), at 1402, as previously described.

At 1404, a first end of the first conductor 1202 is inserted into the compression tube 1273 of the first conductor first portion 1272, as previously described herein. At 1406, a first end of the second conductor 1202′ is inserted into the compression tube 1273′ of the second conductor first portion 1272′, as previously described herein. At 1408, the first conductor first portion 1272 of the coupler 1270 is mechanically compressed (e.g., via backward press crimping) to cause the strength member 1210 of the first conductor 1202 to be coupled to the first conductor first portion 1272 of the coupler 1470, as previously described herein. At 1410, the second conductor first portion 1272′ of the coupler 1270′ is mechanically compressed (e.g., via backward crimping) to cause the strength member 1210′ of the second conductor 1210′ to be coupled to the coupler 1270′, as previously described herein. In some embodiments, operation 1408 may be performed prior to operation 1406.

At 1412, the second portion 1280 is coupled to the compression tubes 1273, 1273′ of the first conductor first portion 1272 and second conductor first portion 1272′, as previously described herein. In some embodiments, optical fibers 1250, 1250′ extending out of the cores 1212, 1212′ of the first conductor 1202 and the second conductor 1202′ respectively, are coupled to each other, for example, via optical couplers 1253a, 1253b, for example, via the access window 1289, as previously described herein,

At 1414, a third portion 1290 of the coupler 1270 can be disposed around at least a portion of the first conductor 1202 (e.g., axial end of the first conductor layer 1220), the second conductor 1202′ (e.g., axial end of the second conductor layer 1220′), first conductor first portion 1272, second conductor first portion 1272′, and the second portion 1280 of the coupler 1270, as previously described herein. At 1416, the third portion 1290 of the coupler 1270 is mechanically compressed (e.g., via backward press crimping) to the first conductive layer 1220 of the first conductor 1202, the second conductive layer 1220′ of the second conductor 1202′, and optionally, the second portion 1280 of the coupler 1270, as previously described herein.

As used herein, the terms “about” and “approximately” generally mean plus or minus 10% of the stated value. For example, about 0.5 would include 0.45 and 0.55, about 10 would include 9 to 11, about 1000 would include 900 to 1100.

As utilized herein, the terms “substantially’ and similar terms are intended to have a broad meaning in harmony with the common and accepted usage by those of ordinary skill in the art to which the subject matter of this disclosure pertains. For example, the term “substantially flat” would mean that there may be de minimis amount of surface variations or undulations present due to manufacturing variations present on an otherwise flat surface. It should be understood by those of skill in the art who review this disclosure that these terms are intended to allow a description of certain features described and claimed without restricting the scope of these features to the precise arrangements and/or numerical ranges provided. Accordingly, these terms should be interpreted as indicating that insubstantial or inconsequential modifications or alterations of the subject matter described and claimed are considered to be within the scope of the inventions as recited in the appended claims.

The terms “coupled,” and the like as used herein mean the joining of two members directly or indirectly to one another. Such joining may be stationary (e.g., permanent) or moveable (e.g., removable, or releasable). Such joining may be achieved with the two members, or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions, and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
removing a portion of a first conductor layer from an end of a first conductor to expose a portion of a first strength member;
inserting the end of the first strength member into a channel defined by a coupler;
removing a portion of a second conductor layer from an end of a second conductor to expose a portion of a second strength member;
inserting the end of the second strength member into the channel defined by the coupler;
causing, via a crimping apparatus, backward press crimping of the coupler to the first strength member and the second strength member.

2. The method of claim 1, wherein:
the first and second strength members each include a composite core and an encapsulation layer disposed on the composite core, and
a plurality of grooves are defined on an inner surface the coupler, the plurality of grooves configured to receive a portion of the encapsulation layer during the backward press crimping.

3. The method of claim 1, wherein:
the coupler includes a body defining the channel, and a sleeve disposed around the body, the sleeve having a length that is longer than a length of the body,
inserting the end of the first strength member into the channel causes a portion of the first conductor layer to be disposed in the sleeve, and
inserting the end of the second strength member causes a portion of the second conductor layer to be disposed in the sleeve.

4. The method of claim 3, wherein the coupler further includes:
a plurality of grooves defined on an inner surface of the body, the plurality of grooves configured to receive a portion of the first strength member and the second strength member during the backward press crimping.

5. The method of claim 4, wherein:
the plurality of grooves is a first plurality of grooves, and
the coupler further includes a second plurality of grooves defined in an inner surface of the sleeve, the second plurality of grooves configured to receive a portion of the first conductor layer and the second conductor layer during the backward press crimping.

6. A method, comprising:
removing a portion of a first conductor layer from an end of a first conductor to expose a portion of a first strength member;
inserting the end of the first strength member into a channel defined by a coupler;
removing a portion of a second conductor layer from an end of a second conductor to expose a portion of a second strength member;
inserting the end of the second strength member into the channel defined by the coupler;
disposing a swage apparatus around the coupler in a first position in which a gap exists between an inner surface of the swage apparatus and the coupler; and
transitioning the swage apparatus from the first position to a second position in which the inner surface of the swage apparatus contacts the coupler and causes backward press crimping of the coupler to the first strength member and the second strength member.

7. The method of claim 6, wherein:
the coupler includes a body defining the channel, and a sleeve disposed around the body, the sleeve having a length that is longer than a length of the body,
inserting the end of the first strength member into the channel causes a portion of the first conductor layer to be disposed in the sleeve, and
inserting the end of the second strength member causes a portion of the second conductor layer to be disposed in the sleeve.

8. The method of claim 7, wherein:
transitioning the swage apparatus from the first to the second position causes the body to be coupled to the first and second strength members, and the sleeve to be coupled to the first and second conductor layers via backward press crimping.

9. The method of claim 8, wherein:
the body and the sleeve have inner cross-sectional widths that are larger than corresponding outer cross-sectional widths of the first and second strength members and the first and second conductor layers, respectively such that a gap is present between inner surfaces of the body and the sleeve and corresponding outer surfaces of the first and second strength members and the first and second conductor layer when the first and second conductors are inserted into the coupler; and
the transitioning of the swage apparatus from the first to the second position causes the body and sleeve to be compressed around the first and second strength members and the first and second conductor layers such that there is substantially no gap between the body and sleeve, and corresponding portions of the first and second strength members and the first and second conductor layers.

10. The method of claim 7, wherein each of the first conductor and the second conductor comprise an optical fiber assembly disposed in the corresponding strength member thereof.

11. The method of claim 10, further comprising:
inserting an optical connector into the channel defined by the coupler,
wherein the first ends of the first and second strength member are coupled to the optical connector to optically couple the optical fiber assembly of the first conductor to the optical fiber assembly of the second conductor.

12. A method, comprising:
removing a portion of a conductor layer from an end of a conductor to expose a portion of a strength member;
inserting an end of the first strength member into a channel defined by a coupler; and
disposing a swage apparatus around the coupler in a first position in which a gap exists between an inner surface of the swage apparatus and the coupler; and
transitioning the swage apparatus from the first position to a second position in which the inner surface of the swage apparatus contacts the coupler and causes backward press crimping of the coupler to the strength member.

13. The method of claim 12, wherein:
the coupler includes a body defining the channel, and a sleeve disposed around the body, the sleeve having a length that is longer than a length of the body,
inserting the end of the strength member into the channel causes a portion of the conductor layer to be disposed in the sleeve.

14. The method of claim 13, wherein:
transitioning the swage apparatus from the first to the second position causes the body to be coupled to the strength member, and the sleeve to be coupled to the conductor layer via the backward press crimping.

15. The method of claim 12, wherein:
the coupler further comprises a connecting portion coupled to a second end of the coupler opposite the end through which the conductor is inserted, and
the method further comprises:
coupling the connecting portion of the coupler to a pole to mount the conductor to the pole.

16. A coupler, comprising:
a first portion including:
a first axial end configured to be coupled to a strength member of a conductor, the strength member including a core including a composite material and an encapsulation layer disposed around the core, a conductor layer disposed around the strength member, the strength member extending beyond an axial edge of the conductor layer to be coupled to the first portion; and
a second axial end having a cross-sectional area greater than a cross-sectional area of the first axial end of the first portion;
a second portion configured to be coupled to the second axial end of the first portion; and
a third portion disposed around at least a portion of the first portion, the second portion, and the conductor, the third portion configured to be coupled to the conductor and the second portion.

17. The coupler of claim 16, wherein a portion of the conductor layer is removed from the end of the conductor to expose a portion of the strength member, the exposed portion of the strength member disposed in the first portion of the coupler.

18. The coupler of claim 16, wherein the first axial end of the first portion is configured to be coupled to the strength member via backward press crimping.

19. The coupler of claim 18, wherein the second axial end of the first portion is structured to direct flow of material of the encapsulation layer due to the backward press crimping away from the core of the strength member.

20. The coupler of claim 16, wherein the second portion includes:
a sleeve defining an inner volume, a first axial end of the sleeve configured to be coupled to the second axial end of the first portion;
a wall coupled to the sleeve; and
a connecting portion coupled to the wall, the connecting portion configured to mount the second portion to at least one of a pole or a tower.

21. The coupler of claim 20, wherein:
the conductor further includes an optical fiber disposed through the core and configured to extend out of the core through the inner volume of the second portion, and
the wall defines an opening configured to allow the optical fiber of the conductor to be inserted therethrough to a region external to the coupler.

22. The coupler of claim 21, wherein the strength member of the conductor is configured to extend through the first portion, the second portion, and the opening of the wall.

23. The coupler of claim 22, further comprising:
a sealing member coupled to the opening, the sealing member configured to form a seal around the strength member extending through the opening.

24. The coupler of claim 21, wherein, the conductor further includes:
a protection sleeve disposed around the optical fiber, the protection sleeve configured to protect the optical fiber during coupling of the strength member to the first portion of the coupler.

25. The coupler of claim 24, wherein the protection sleeve is configured to extend into at least the first portion of the coupler, and the optical fiber extends from the axial end of the protection sleeve into the inner volume defined by the second portion.
